(19) United States
(12) Patent Application Publication
(10) Pub. No.: US 2018/0161984 A1
(43) Pub. Date: Jun. 14, 2018

(54) CONTROL DEVICE, ROBOT, AND ROBOT SYSTEM

(71) Applicant: Seiko Epson Corporation, Tokyo (JP)

(72) Inventor: Taro ISHIGE, Matsumoto (JP)

(21) Appl. No.: 15/830,393

(22) Filed: Dec. 4, 2017

(30) Foreign Application Priority Data
Dec. 9, 2016 (JP) 2016-239872

(51) Int. Cl. B25J 9/16

(52) U.S. Cl. CPC B25J 9/1692; B25J 9/1697; G05B 2219/39045; G05B 2219/39044; G05B 2219/39008

(57) ABSTRACT

A control device, which controls a robot having a movable unit including an arm provided with an imaging unit, includes a processor that obtains a posture of the imaging unit by translating the arm. The processor obtains the posture of the imaging unit, based on a direction of translating the arm and a movement direction in a coordinate system of the imaging unit in response to the translation of the arm.

### BACKGROUND

### 1. Technical Field

The present invention relates to a control device, a robot, and a robot system.

### 2. Related Art

In the related art, a robot system is known which includes a robot having a robot arm provided with an end effector for carrying out work on an object and a camera attached to a distal portion of the robot arm, and a control device for controlling the driving of the robot.

As an example of this robot system, for example, JP-A-2015-66603 discloses a robot system including a robot device having a joint arm provided with a hand and a camera disposed at the arm positioned at the forefront of the joint arm, and a control device for controlling a position and a posture of the robot device. In the robot system, a hand coordinate system of a hand and a camera coordinate system of a camera are set. In the robot system, in order to grip an object by using the hand, based on a captured image of the camera, a robot calibration device performs calibration processing on the hand coordinate system and an image coordinate system.

Here, in the robot system disclosed in JP-A-2015-66603, the camera is disposed in a distal arm, and pivots following pivoting of the distal arm. Therefore, there is a problem in that a wire of the camera is likely to be degraded after being frequently bent due to the rotation of the distal arm. In particular, in a case where the distal arm is frequently moved, the wire is significantly degraded.

### SUMMARY

An advantage of some aspects of the invention is to solve at least a part of the problems described above, and the invention can be implemented as the following configurations.

A control device according to an aspect of the invention controls a robot having a movable unit including an arm provided with an imaging unit. The control device includes a control unit that obtains a posture of the imaging unit by translating the arm.

In the control device according to the aspect of the invention, it is possible to obtain the posture (inclination) of the imaging unit with respect to the arm by translating the arm. Therefore, those other than a distal arm positioned on the most distal side of the movable unit can be used as the arm. As a result, for example, it is possible to minimize a possibility that a wire of the imaging unit pulled from a base by excessively pivoting the distal arm may be degraded after being frequently bent due to the rotation of the distal arm. For example, in applications of a relatively small pivoting amount of the distal arm, the arm provided with the imaging unit may serve as the distal arm.

In the control device according to the aspect, it is preferable that the control unit obtains the posture of the imaging unit, based on a direction of translating the arm and a movement direction in a coordinate system of the imaging unit in response to the translation of the arm.

With this configuration, it is possible to obtain the posture of the imaging unit with respect to the arm without excessively pivoting the movable unit.

In the control device according to the aspect, it is preferable that the control unit obtains an offset of the imaging unit with respect to the arm, based on a marker imaged by the imaging unit.

With this configuration, for example, it is unnecessary to measure the offset by using a measure (measuring instrument). Therefore, it is possible to minimize artificial variations caused by causing the measure (measuring instrument) to measure the offset, for example. The offset can be calculated in a non-contact manner. Accordingly, it is possible to more accurately calculate the offset regardless of a material of an object, for example.

In the control device according to the aspect, it is preferable that the control unit obtains the offset, based on a first image in which the marker is imaged by positioning the imaging unit at a first imaging posture and a second image in which the marker is imaged by positioning the imaging unit at a second imaging posture.

With this configuration, the offset can be calculated in the non-contact manner, and the offset can be more accurately calculated using a relatively simple method.

In the control device according to the aspect, it is preferable that the movable unit includes a distal arm disposed on a distal side of the movable unit from the arm.

With this configuration, those other than the distal arm positioned on the most distal side of the movable unit can be used as the arm provided with the imaging unit. Accordingly, for example, it is possible to minimize a possibility that the wire of the imaging unit pulled from a proximal side of the robot may be degraded after being frequently bent due to the rotation of the distal arm. In this regard, an advantageous effect can be remarkably achieved.

In the control device according to the aspect, it is preferable that the robot has a base which supports the movable unit, the arm is capable of pivoting with respect to the base, the distal arm is capable of pivoting with respect to the arm, and the control unit moves the imaging unit to a designated position and posture, based on the pivoting of the imaging unit pivoting in response to the pivoting of the arm.

With this configuration, the imaging unit can be properly positioned at the designated position and posture.

In the control device according to the aspect, it is preferable that the control unit controls the movable unit so that the movable unit does not appear in a captured image captured by the imaging unit.

With this configuration, for example, even if the marker is imaged by the imaging unit disposed in the arm different from the arm positioned on the most distal side, it is possible to avoid the movable unit from appearing in the captured image. Therefore, the offset can be more accurately calculated using the captured image.

In the control device according to the aspect, it is preferable that the imaging unit is capable of imaging a distal side of the movable unit, and the control unit controls the movable unit so that a distal portion of the movable unit does not appear in the captured image.

With this configuration, even if the marker is imaged by the imaging unit disposed in the arm different from the arm positioned on the most distal side, it is possible to avoid the distal portion (for example, an end effector) of the movable unit from appearing in the captured image. Therefore, the offset can be more accurately calculated using the captured image.

A robot according to an aspect of the invention is controlled by the control device according to the aspect of the invention and has a movable unit including an arm provided with an imaging unit.

According to the robot, the robot can accurately perform the operation relating to the calculation of the offset. For example, it is possible to minimize a possibility that the wire of the imaging unit pulled from the proximal side of the robot may be degraded after being frequently bent due to the rotation of the distal arm.

A robot system according to an aspect of the invention includes the control device according to the aspect of the invention, an imaging unit, and a robot controlled by the control device and having a movable unit including an arm provided with an imaging unit.

According to the robot system, under the control of the control device, the robot can accurately perform the operation relating to the calculation of the offset. For example, it is possible to minimize a possibility that the wire of the imaging unit pulled from the proximal side of the robot may be degraded after being frequently bent due to the rotation of the distal arm.

### BRIEF DESCRIPTION OF THE DRAWINGS

The invention will be described with reference to the accompanying drawings, wherein like numbers reference like elements.

FIG. 1 is a perspective view of a robot system according to a first embodiment.

FIG. 2 is a system configuration diagram of the robot system illustrated in FIG. 1.

FIG. 3 is a side view illustrating a robot belonging to the robot system illustrated in FIG. 1.

FIG. 4 is a flowchart illustrating a flow of calibration performed by the robot system illustrated in FIG. 1.

FIG. 5 is a view for describing Step S13 illustrated in FIG. 4.

FIG. 6 is a view for describing Step S13 illustrated in FIG. 4.

FIG. 7 is a view for describing Step S15 illustrated in FIG. 4.

FIG. 8 is a view illustrating a captured image for describing Step S152 illustrated in FIG. 7.

FIG. 9 is a view illustrating a first region and an object appearing in the captured image for describing Step S153 illustrated in FIG. 7.

FIG. 10 is a view illustrating a second search window set in Step S153 illustrated in FIG. 7.

FIG. 11 is a schematic view of a robot for describing Step S16 illustrated in FIG. 4.

FIG. 12 is a schematic view of the robot for describing Step S16 illustrated in FIG. 4.

FIG. 13 is a view illustrating a captured image for describing Step S16 illustrated in FIG. 4.

FIG. 14 is a view illustrating a captured image for describing Step S16 illustrated in FIG. 4.

FIG. 15 is a view illustrating a captured image for describing Step S16 illustrated in FIG. 4.

FIG. 16 is a view illustrating a captured image for describing Step S16 illustrated in FIG. 4.

FIG. 17 is a flowchart for describing Step S17 illustrated in FIG. 4.

FIG. 18 is a schematic view of the robot for describing Step S171 illustrated in FIG. 17.

FIG. 19 is a schematic view of the robot for describing Step S171 illustrated in FIG. 17.

FIG. 20 is a schematic view of the robot for describing Step S172 illustrated in FIG. 17.

FIG. 21 is a schematic view of the robot for describing Step S173 illustrated in FIG. 17.

FIG. 22 is a schematic view of the robot for describing Step S174 illustrated in FIG. 17.

FIG. 23 is a schematic view of the robot for describing Step S22 illustrated in FIG. 4.

FIG. 24 is a view illustrating robot coordinates for describing Step S22 illustrated in FIG. 4.

FIG. 25 is a schematic view of the robot for describing Step S22 illustrated in FIG. 4.

FIG. 26 is a view illustrating a captured image for describing Step S24 illustrated in FIG. 4.

FIG. 27 is a view illustrating a captured image for describing Step S24 illustrated in FIG. 4.

FIG. 28 is a perspective view of a robot system according to a second embodiment.

FIG. 29 is a side view illustrating a robot belonging to the robot system illustrated in FIG. 28.

FIG. 30 is a flowchart illustrating a flow of calibration performed by the robot system illustrated in FIG. 28.

FIG. 31 is a view illustrating a flow of offset calculation performed by a robot system according to a third embodiment.

FIG. 32 is a perspective view of a robot for describing Steps S31 and S32 illustrated in FIG. 31.

FIG. 33 is a view for describing Step S34 illustrated in FIG. 31.

FIG. 34 is a view for describing Step S34 illustrated in FIG. 31.

FIG. 35 is a view for describing Step S35 illustrated in FIG. 31.

FIG. 36 is a view illustrating a distal portion of a robot belonging to a robot system according to a fourth embodiment.

FIG. 37 is a view illustrating a state where a hand belonging to the robot illustrated in FIG. 36 is translated.

FIG. 38 is a view illustrating a captured image in a state of the robot illustrated in FIG. 36.

FIG. 39 is a view illustrating a captured image in a state of the robot illustrated in FIG. 37.

FIG. 40 is a flowchart illustrating a process for positioning a mobile camera installed in a robot arm illustrated in FIG. 36 in a target location.

FIG. 41 is a view for describing Step S55 illustrated in FIG. 40.

FIG. 42 is a flowchart illustrating a state where a hand is positioned within the field of view of mobile camera in the robot illustrated in FIG. 36.

### DESCRIPTION OF EXEMPLARY EMBODIMENTS

Hereinafter, a control device, a robot, and a robot system according to the invention will be described in detail with reference to preferred embodiments illustrated in the accompanying drawings.

### First Embodiment

### Robot System

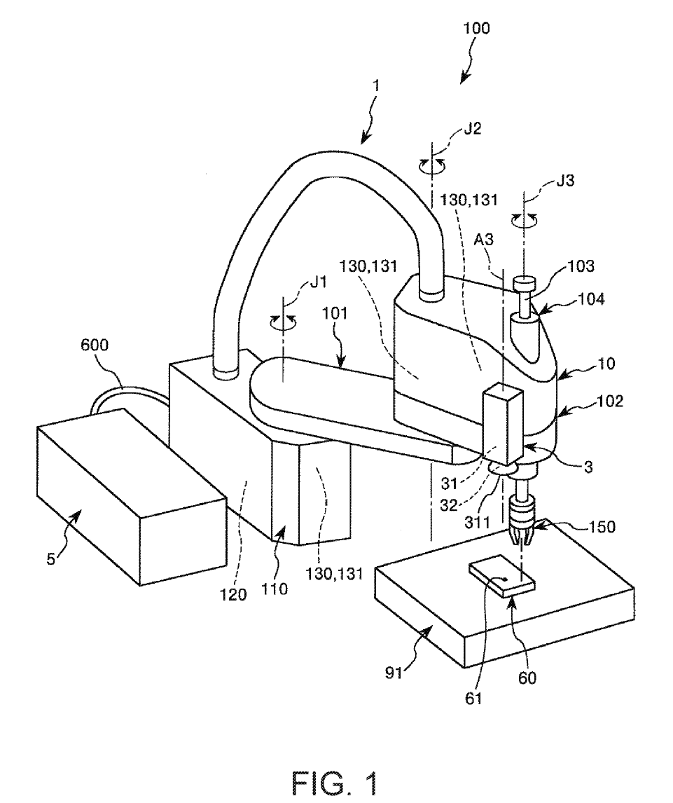

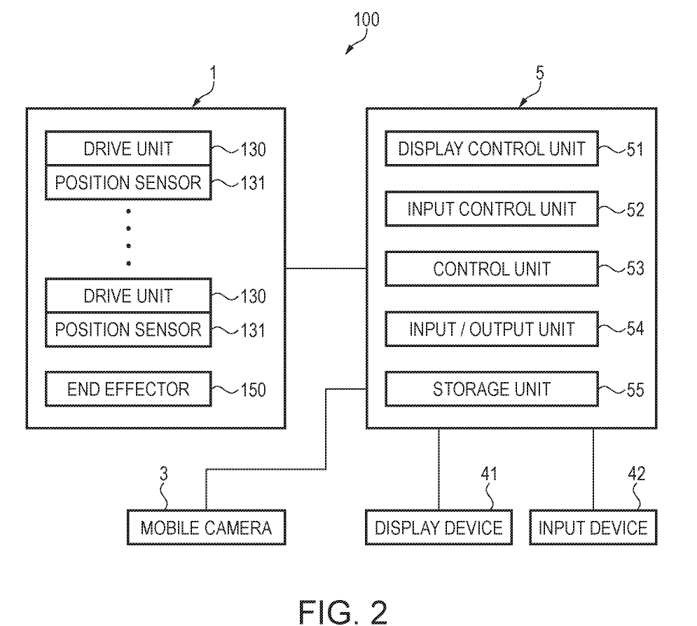

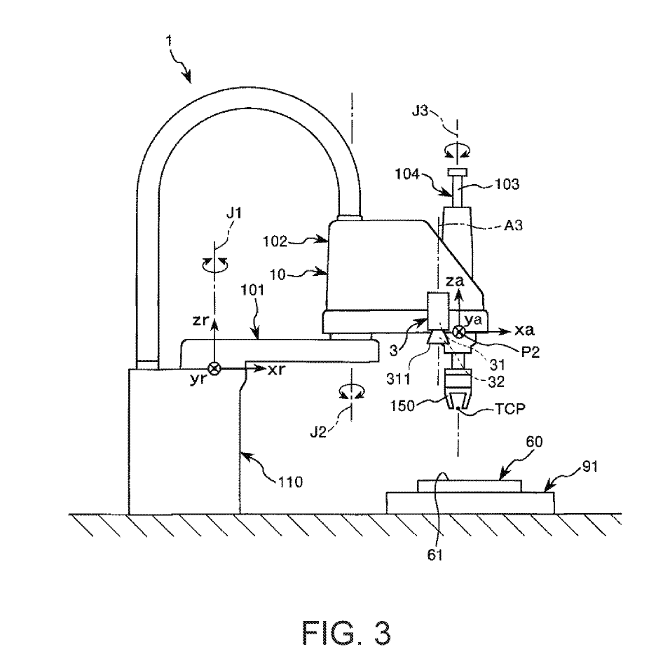

FIG. 1 is a perspective view of a robot system according to a first embodiment. FIG. 2 is a system configuration diagram of the robot system illustrated in FIG. 1. FIG. 3 is a side view illustrating a robot belonging to the robot system illustrated in FIG. 1. For convenience of the following description, an upper side in FIG. 3 is referred to as “upper”, and a lower side is referred to as “lower”. A base 110 side in FIG. 3 is referred to as a “proximal end”, and a side opposite thereto (hand 150 side serving as an end effector) is referred to as a “distal end”. An upward/downward direction in FIG. 3 is defined as a “perpendicular direction”, and a rightward/leftward direction is defined as a “horizontal direction”. In the description herein, the term “horizontal” includes not only a case of being perfectly horizontal, but also a case of being inclined from the horizontal line within ±5°. Similarly, in the description herein, the term “perpendicular” includes not only a case of being perfectly perpendicular, but also a case of being inclined from the perpendicular line within ±5°. In the description herein, the term “parallel” includes not only a case where two lines (including axes) or planes are perfectly parallel to each other, but also a case of being inclined from each other within ±5°.

For example, a robot system 100 illustrated in FIG. 1 is a device used in carrying out work for holding, transporting, and assembling a target member such as an electronic component and an electronic device. As illustrated in FIG. 1, the robot system 100 includes a robot 1, a mobile camera 3 (imaging unit) having an imaging function attached to the robot 1, and a control device 5 (calibration device) which controls each of the robot 1 and the mobile camera 3. As illustrated in FIG. 2, the robot system 100 has a display device 41 and an input device 42 (operating device).

### Robot

Hereinafter, each unit belonging to the robot system 100 will be sequentially described.

The robot 1 is a so-called horizontally articulated robot (scalar robot). For example, the robot 1 can hold or transport a target member such as precision instruments or components. As illustrated in FIG. 1, the robot 1 has a base 110 and a robot arm 10 (movable unit) connected to the base 110. The robot arm 10 has a first arm 101 (arm), a second arm 102 (arm), a work head 104, and a hand 150. As illustrated in FIGS. 1 and 2, the robot 1 has a plurality of drive units 130 generating power for driving the robot arm 10, and a position sensor 131.

The base 110 is a portion for attaching the robot 1 to any desired installation location. The installation location of the base 110 is not particularly limited. For example, the installation location includes a floor, a wall, a ceiling, and a movable carriage.

A first arm 101 pivotable around a first axis J1 (pivot axis) along a perpendicular direction with respect to the base 110 is connected to an upper end portion of the base 110. A second arm 102 pivotable around a second axis J2 (pivot axis) along the perpendicular direction with respect to the first arm 101 is connected to a distal portion of the first arm 101. The work head 104 is disposed in a distal portion of the second arm 102. The work head 104 has a spline shaft 103 (arm, distal arm) inserted into a spline nut and a ball screw nut (none of them illustrated) which are coaxially disposed in the distal portion of the second arm 102. The spline shaft 103 is pivotable around a third axis J3 with respect to the second arm 102, and is movable (capable of ascending and descending) in the upward/downward direction. Here, in the embodiment, as illustrated in FIG. 3, a point where the distal portion (lower end surface of the distal portion) of the second arm 102 intersects the third axis J3 is referred to as an axis coordinate P2 (predetermined portion) of the second arm 102.

As illustrated in FIG. 1, the hand 150 serving as an end effector and having two fingers capable of gripping a target member is detachably attached to the distal portion (lower end portion) of the spline shaft 103. In the embodiment, the hand 150 is used as the end effector. However, the end effector may adopt any configuration as long as the end effector has a function to carry out work for various target members (holding the target members).

The hand 150 is attached to the spline shaft 103 so that a center axis of the hand 150 coincides with the third axis J3 of the spline shaft 103 in design. Therefore, the hand 150 pivots in response to the pivoting of the spline shaft 103. As illustrated in FIG. 3, a distal center of the hand 150 is called a tool center point TCP. In the embodiment, the tool center point TCP is the center of a region between the two fingers belonging to the hand 150.

As illustrated in FIG. 1, the drive unit 130 which drives (pivots) the first arm 101 is installed in the base 110. Similarly, the drive unit 130 which drives the second arm 102 and the drive unit 130 which drives the spline shaft 103 are installed in the second arm 102. That is, the robot 1 has three drive units 130. The drive unit 130 has a motor (not illustrated) for generating a driving force and a speed reducer (not illustrated) for decelerating the driving force of the motor. For example, as the motor belonging to the drive unit 130, a servo motor such as an AC servo motor and a DC servo motor can be used. For example, as the speed reducer, a planetary gear-type speed reducer or a wave-motion gear device can be used. Each drive unit 130 has the position sensor 131 (angle sensor) which detects a rotation angle of a rotary shaft of the motor or the speed reducer (refer to FIGS. 1 and 2).

Each drive unit 130 is electrically connected to the motor driver 120 incorporated in the base 110 illustrated in FIG. 1. Each drive unit 130 is controlled by the control device 5 via the motor driver 120.

In the robot 1 having this configuration, as illustrated in FIG. 3, as a base coordinate system based on the base 110 of the robot 1, a three-dimensional orthogonal coordinate system is set which is defined by an xr-axis and a yr-axis which are respectively parallel to the horizontal direction, and a zr-axis orthogonal to the horizontal direction and having a perpendicularly upward direction as a positive direction. In the embodiment, as an original point, the base coordinate system has the center point on the upper end surface of the base 110. A translation component for the xr-axis is set as a “component xr”, a translation component for the yr-axis is set as a “component yr”, a translation component for the zr-axis is set as a “component zr”, a rotation component around the zr-axis is set as a “component ur”, a rotation component around the yr-axis is set as a “component vr”, and a rotation component around the-xr axis is set as a “component wr”. The unit of the length (size) of the component xr, the component yr, and the component zr is expressed using “mm”, and the unit of the angle (size) of the component ur, the component vr, and the component wr is expressed using “degree (°)”.

In the robot 1, a distal coordinate system based on the distal portion of the second arm 102 of the robot 1 is set. The distal coordinate system is a three-dimensional orthogonal coordinate system defined by an xa-axis, a ya-axis, and a za-axis which are orthogonal to each other. In the embodiment, as the original point, the distal coordinate system has an axis coordinate P2 of the second arm 102. The calibration between the base coordinate system and the distal coordinate system is previously completed. The robot 1 is in a state where the coordinates of the distal coordinate system can be calculated, based on the base coordinate system. A translation component for the xa-axis is set as a “component xa”, a translation component for the ya-axis is set as a “component ya”, a translation component for the za-axis is set as a “component za”, a rotation component around the za-axis is set as a “component ua”, a rotation component around the ya-axis is set as a “component va”, and a rotation component around the xa-axis is set as a “component wa”. The unit of the length (size) of the component xa, the component ya, and the component za is expressed using “mm”, and the unit of the angle (size) of the component ua, the component va, and the component wa is expressed using “degree (°)”.

Hitherto, a configuration of the robot 1 has been briefly described. Although not illustrated, for example, the robot 1 may include a force detection unit configured to include a force sensor (for example, a six-axis force sensor) which detects a force (including a moment) applied to the hand 150.

### Mobile Camera

As illustrated in FIG. 1, the mobile camera 3 is disposed in the distal portion of the second arm 102 of the robot 1. The mobile camera 3 has a function to image an object 60 placed on a work table 91, for example. The object 60 is a member used for calibration (to be described later). For example, a circular marker 61 is attached to the object 60.

The mobile camera 3 has an image sensor element 31 configured to include a charge coupled device (CCD) image sensor having a plurality of pixels, and a lens 32 (optical system). The mobile camera 3 converts light into an electric signal by causing the lens 32 to form an image of the light from an imaging target on the light receiving surface 311 (sensor surface) of the image sensor element 31, and outputs the converted electric signal to the control device 5. Here, the light receiving surface 311 is a surface of the image sensor element 31 on which the light forms the image.

This mobile camera 3 is attached to the second arm 102 so as to image the distal side of the robot arm 10. Therefore, in the embodiment, the mobile camera 3 can capture an image downward in the perpendicular direction. In the embodiment, the mobile camera 3 is attached to the second arm 102 so that an optical axis A3 of the mobile camera 3 (optical axis of the lens 32) is parallel to the third axis J3 of the spline shaft 103. The mobile camera 3 is disposed in the second arm 102. Accordingly, the position of the mobile camera 3 can be changed together with the driving (pivoting) of the second arm 102.

In this mobile camera 3, as the image coordinate system (coordinate system of a captured image 30 output from the mobile camera 3) of the mobile camera 3, a two-dimensional orthogonal coordinate system defined by the xb-axis and the yb-axis which are parallel to each other in an in-lane direction of the captured image 30 is set (refer to FIG. 6). The translation component for the xb-axis is set as a “component xb”, the translation component for the yb-axis is set as a “component yb”, and the rotation component around the normal line on an xb-yb plane is set as a “component ub”. The unit of the length (size) of the component xb and the component yb is expressed using “pixel”, and the unit of the angle (size) of the component ub is expressed using “degree (°)”. The image coordinate system of the mobile camera 3 is a two-dimensional orthogonal coordinate system in which three-dimensional orthogonal coordinates appearing in the camera field of view of the mobile camera 3 are subjected to nonlinear transformation in view of optical characteristics (focal length or distortion) of the lens 32, and the number of pixels and the size of the image sensor element 31.

### Control Device

The control device 5 illustrated in FIG. 1 controls the driving (operation) of each unit of the robot 1 and the mobile camera 3. For example, the control device 5 can be configured to include a personal computer (PC), in which a central processing unit (CPU), a read only memory (ROM), and a random access memory (RAM) are incorporated. As illustrated in FIG. 1, the control device 5 is connected to the robot 1 via a wire 600. The robot 1 and the control device 5 may be connected to each other by means of wireless communication. In the embodiment, the control device 5 is disposed separately from the robot 1, but may be incorporated in the robot 1. As illustrated in FIG. 2, the display device 41 including a monitor (not illustrated) such as a display and the input device 42 including a mouse or a keyboard are connected to the control device 5.

Hereinafter, each function (function unit) of the control device 5 will be described.

As illustrated in FIG. 2, the control device 5 includes a display control unit 51, an input control unit 52, a control unit 53 (robot control unit), an input/output unit 54, and a storage unit 55.

The display control unit 51 is configured to include a graphic controller, for example, and is connected to the display device 41. The display control unit 51 has a function to display various screens (for example, operation screens) on the monitor of the display device 41. The input control unit 52 is connected to the input device 42, and has a function to receive an input from the input device 42.

The control unit 53 has a function to control the driving of the robot 1 and the operation of the mobile camera 3, and a function to perform processes for various calculations and determinations. For example, the control unit 53 is configured to include a CPU. Each function of the control unit 53 can be realized by causing the CPU to execute various programs stored in the storage unit 55.

Specifically, the control unit 53 controls the driving of each drive unit 130 so as to drive or stop the robot arm 10. For example, based on the information output from the position sensor 131 disposed in each drive unit 130, the control unit 53 derives a target value of a motor (not illustrated) belonging to each drive unit 130 in order to move the hand 150 to a target position. The control unit 53 performs the processes for various calculations and various determinations, based on the information acquired by the input/output unit 54 and transmitted from the position sensor 131 and the mobile camera 3. For example, the control unit 53 calculates coordinates (components xb, yb, ub: position and the posture) of an imaging target in the image coordinate system, based on the captured image 30 captured by the mobile camera 3. For example, the control unit 53 obtains calibration parameters for transforming coordinates (image coordinates) in the image coordinate system of the mobile camera 3 into coordinates (robot coordinates) in the distal coordinate system of the robot 1 or coordinates (base coordinates) in the base coordinate system of the robot 1. In the embodiment, the distal coordinates of the robot 1 are regarded as the “robot coordinates”, but the base coordinates may be regarded as the “robot coordinates”.

For example, the input/output unit 54 (information acquisition unit) is configured to include an interface circuit, and has a function to exchange information with the robot 1 and the mobile camera 3. For example, the input/output unit 54 has a function to acquire information such as a rotation angle of a rotary shaft of the motor or speed reducer belonging to each drive unit 130 of the robot 1, and the captured image 30. For example, the input/output unit 54 outputs the target value of the motor derived from the control unit 53 to the robot 1.

For example, the storage unit 55 is configured to include a RAM and a ROM, and stores programs and various data items for the control device 5 to perform various processes. For example, the storage unit 55 stores a program for performing calibration. The storage unit 55 is not limited to those which are incorporated in the control device 5 (RAM and ROM), and may be configured to have a so-called external storage device (not illustrated).

As described above, the display device 41 includes the monitor (not illustrated) such as a display, and has a function to display the captured image 30, for example. Therefore, a worker can confirm the captured image 30 and work of the robot 1 via the display device 41. As described above, the input device 42 is configured to include the mouse or the keyboard, for example. Therefore, the worker operates the input device 42, thereby enabling the worker to issue various process instructions to the control device 5. Instead of the display device 41 and the input device 42, a display input device (not illustrated) which serves as both the display device 41 and the input device 42 may be used. For example, as the display input device, a touch panel can be used.

Hitherto, the basic configuration of the robot system 100 has been briefly described. In this robot system, the robot 1 is caused to carryout the work, based on the captured image 30. For this purpose, it is necessary to obtain a transformation matrix equation (calibration parameter) which transforms the image coordinates (xb, yb, and ub) to the robot coordinates (xa, ya, and ua). That is, calibration (mapping) is needed between the mobile camera 3 and the robot 1. In accordance with an instruction from the worker, this calibration is automatically performed by the control device 5, based on a program for performing the calibration.

Hereinafter, the calibration (various settings and performances for the calibration) will be described.

### Calibration

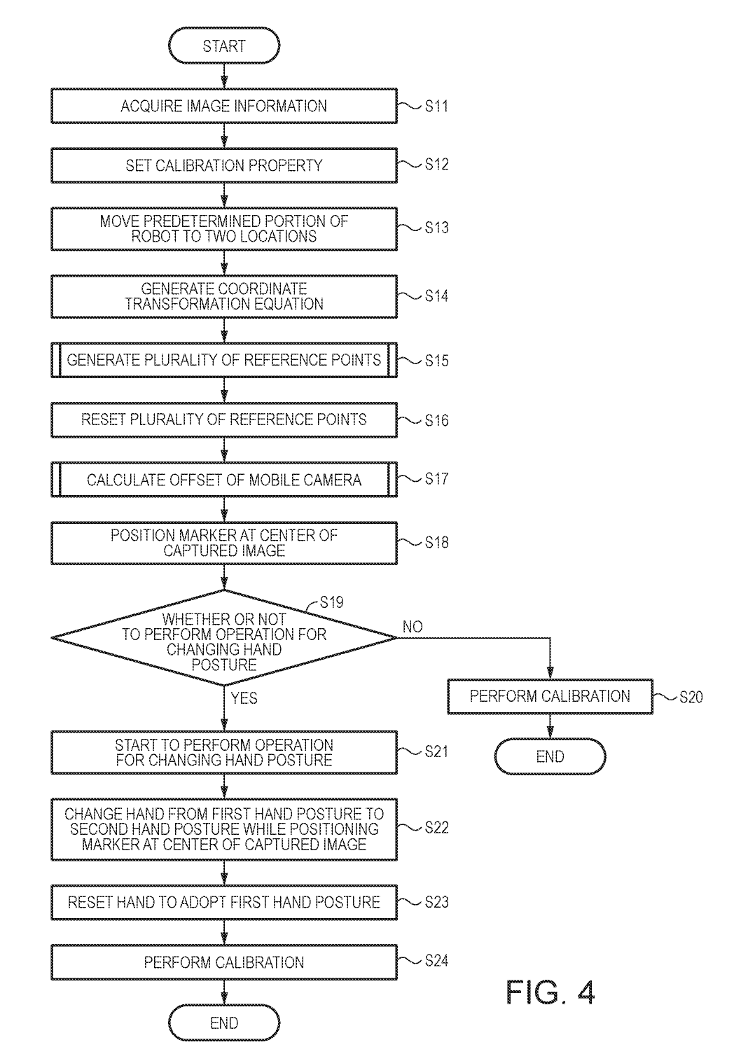

FIG. 4 is a flowchart illustrating a flow of the calibration performed by the robot system illustrated in FIG. 1.

Before the calibration is performed, the worker places the object 60 on the work table 91 as illustrated in FIG. 1. The worker drives the robot arm 10, for example, by means of so-called jog feeding (by a manual instruction via the display device 41 using the input device 42), and positions the axis coordinate P2 of the second arm 102 to a position where the marker 61 can be imaged using the mobile camera 3. Thereafter, the worker instructs the control device 5 to start the calibration, thereby causing the control device 5 to start the calibration. Thereafter, under the control of the control device 5, the calibration can be automatically performed. Therefore, no operation is performed by the worker at all. Alternatively, the calibration can be performed using only a simple operation of the worker.

Hereinafter, each process (Step) will be described with reference to a flowchart illustrated in FIG. 4.

### Acquisition of Image Information (FIG. 4: Step S11)

First, the input/output unit 54 acquires image information of the mobile camera 3, and the storage unit 55 stores the acquired image information. The image information means information on the number of pixels of the mobile camera 3.

### Setting of Calibration Property (FIG. 4: Step S12)

Next, the control unit 53 performs calibration property setting. Specifically, the calibration property setting means setting of the speed and acceleration of the robot 1 when the calibration is performed (more specifically, the movement speed of the hand 150 or the movement acceleration, for example), and setting of a local plane (work plane). The speed and the acceleration of the robot 1 when the calibration is performed are not particularly limited. However, it is preferable that the speed and the acceleration are 30 to 70% of the maximum speed and the maximum acceleration. In this manner, it is possible to further minimize variations in obtaining results of the calibration, and it is possible to further improve the accuracy of the calibration.

Next, the control unit 53 performs Steps S13 and S14 so as to obtain a relative relationship between the distal coordinate system and the image coordinate system.

### Moving a Predetermined Portion of the Robot to Two Locations (FIG. 4: Step S13)

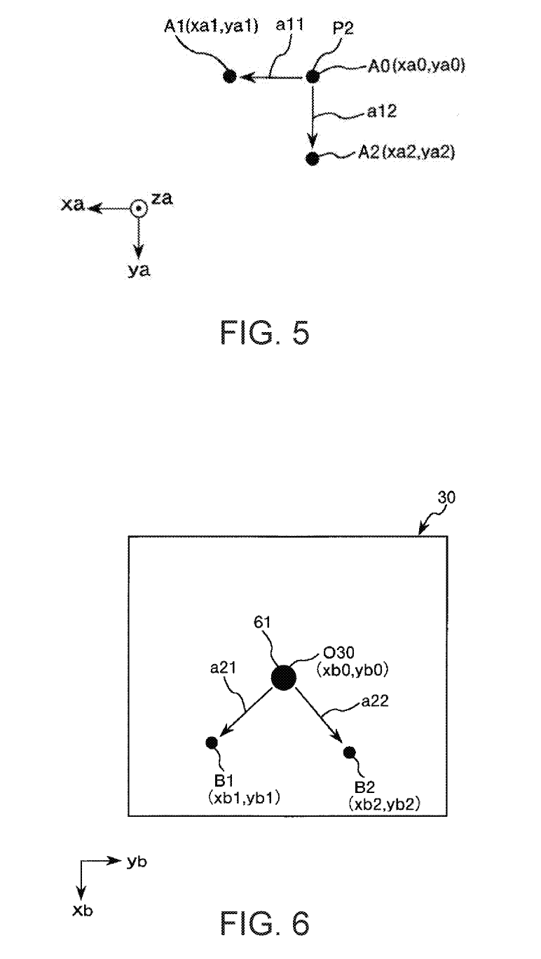

FIGS. 5 and 6 are views for respectively describing Step S13 illustrated in FIG. 4.

Next, the control unit 53 moves the predetermined portion (in the embodiment, the axis coordinate P2) of the robot 1 from a point A0 to two different points A1 and A2 different from the point A0, and acquires the image coordinates of the marker 61 appearing on the captured image 30 when the predetermined portion moves to the points A1 and A2 from the point A0 (refer to FIGS. 5 and 6).

Specifically, first, the control unit 53 drives the robot arm 10 so that the marker 61 is positioned (so as to appear) at a center O30 of the captured image 30, and acquires image data from the mobile camera 3 (refer to FIGS. 5 and 6). A position of the axis coordinate P2 of the robot 1 when the marker 61 is positioned at the center O30 of the captured image 30 is set as a point A0. It is assumed that the point A0 is taught in advance. The storage unit 55 stores the robot coordinates (xa0 and ya0) at the point A0 and the image coordinates (xb0 and yb0) at the center O30. It is preferable that the point A0 is located near the center O30 of the captured image 30. However, the point A0 is not limited to the center O30 as long as the point A0 is located within the captured image 30 (within the field of view of the mobile camera 3). Points A1 and A2 (to be described later) may also be located anywhere within the captured image 30.

Next, the control unit 53 drives the robot arm 10, moves the axis coordinate P2 from the point A0 in a direction of an arrow all in FIG. 5 so as to be positioned at the point A1, and acquires the image data from the mobile camera 3. For example, the axis coordinate P2 is moved 10 mm from the point A0 in the xa-direction, and is moved 0 mm in the ya-direction so as to be positioned at the point A1 (refer to FIG. 5). At this time, the marker 61 (marker recognition position) appearing in the captured image 30 moves from the center O30 in a direction of an arrow a21 and is positioned at a point B1 (refer to FIG. 6). The storage unit 55 stores the robot coordinates (xa1 and ya1) at the point A1 and the image coordinates (xb1 and yb1) at the point B1 (refer to FIGS. 5 and 6).

The control unit 53 drives the robot arm 10, moves the axis coordinate P2 from the point A0 in a direction of an arrow a12 so as to be positioned at the point A2, and acquires the image data from the mobile camera 3. For example, the axis coordinate P2 is moved 0 mm from the point A0 in the xa-direction, and is moved 10 mm in the ya-direction so as to be positioned at the point A2 (refer to FIG. 5). At this time, the marker 61 appearing in the captured image 30 moves from the center O30 in a direction of an arrow a22 and is positioned at the point B2 (refer to FIG. 6). The storage unit 55 stores the robot coordinates (xa2 and ya2) at the point A2 and the image coordinated (xb2 and yb2) at the point B2 (refer to FIGS. 5 and 6).

A movement amount from the point A0 to the points A1 and A2 is not limited to the above-described numerical value. The movement amount may be optionally determined.

### Generation of a Coordinate Transformation Equation (FIG. 4: Step S14)

Next, based on three robot coordinates and three image coordinates stored in Step S13, the control unit 53 obtains a coordinate transformation equation between the robot coordinates and the image coordinates by using a coordinate transformation equation (Equation (1)) for transforming the coordinates to the robot coordinates and the image coordinate.

$$( \begin{matrix}Δ xb \\ Δ yb\end{matrix} ) = ( \begin{matrix}a & b \\ c & d\end{matrix} ) ( \begin{matrix}Δ xa \\ Δ ya\end{matrix} ) \qquad ( 1 )$$

Δxb and Δyb in Equation (1) represent a distance (displacement) between two points in the image coordinate system, and Δxa and Δya represent a distance (displacement) between two points in the distal coordinate system. In addition, a, b, c, and d are unknown variables.

The variables a and b are obtained as follows, from Equation (1), the points A0 and A1, the center O30, and the point B1.

$$\begin{matrix}Δ xb 1 = xb 1 - xb 0 & Δ xb 1 = 10 \cdot a +\end{matrix} 0 \cdot b$$

$$\begin{matrix}Δ yb 1 = yb 1 - yb 0 & Δ yb 1 = 10 \cdot c + 0 \cdot d\end{matrix} \\ ⇒ a = Δ xb 1 / 10 c = Δ yb 1 / 10$$

Similarly, the variables c and d are obtained as follows from Equation (1), the points A0 and A2, the center O30, and the point B2.

$$\begin{matrix}Δ xb 2 = xb 2 - xb 0 & Δ xb 2 = 0 \cdot a +\end{matrix} 10 \cdot b$$

$$\begin{matrix}Δ yb 2 = yb 2 - yb 0 & Δ yb 2 = 0 \cdot c + 10 \cdot d\end{matrix} \\ ⇒ b = Δ xb 2 / 10 d = Δ yb 2 / 10$$

The variables a, b, c, and d are obtained in this way, and a coordinate transformation equation (primary transformation matrix) can be generated. In this manner, a relative relationship between the distal coordinate system and the image coordinate system can be obtained, and displacement (movement amount) in the image coordinate system can be transformed into displacement (movement amount) in the distal coordinate system. In this way, the coordinate transformation equation (affine transformation equation) illustrated in Equation (1) is used, based on three robot coordinates and image coordinates obtained by moving the axis coordinate P2 to three different locations. In this manner, the relative relationship between the distal coordinate system and the image coordinate system can be easily and properly obtained.

In the embodiment, the process in Step S14 is performed after the process in Step S13 is performed. However, these processes may be performed at the same time.

### Generation of a Plurality of Reference Points (FIG. 4: Step S15)

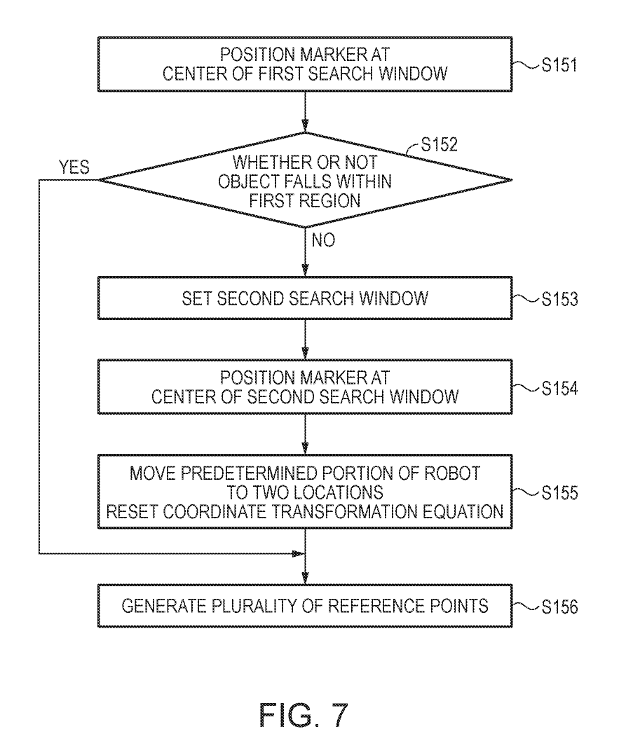

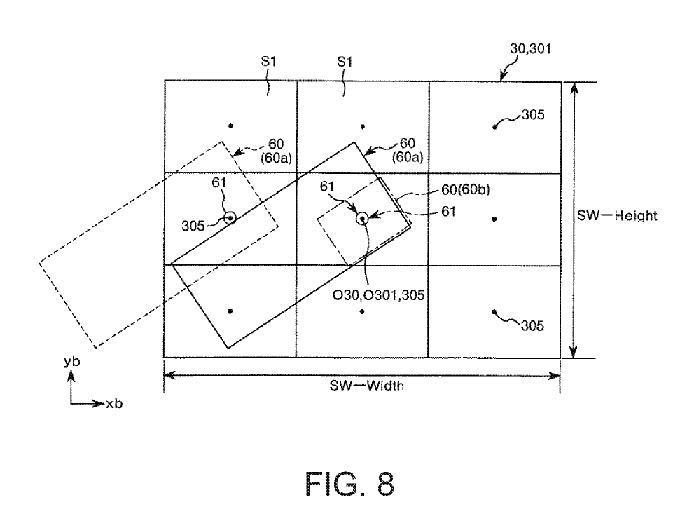

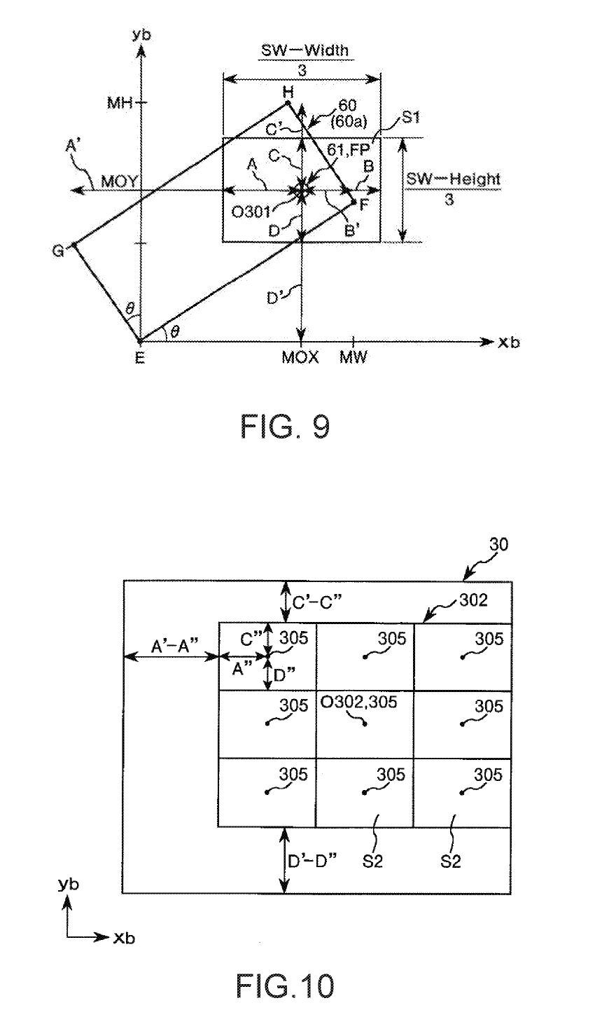

FIG. 7 is a flowchart for describing Step S15 illustrated in FIG. 4. FIG. 8 is a view illustrating the captured image for describing Step S152 illustrated in FIG. 7. FIG. 9 is a view illustrating the first region and the object appearing in the captured image for describing Step S153 illustrated in FIG. 7. FIG. 10 is a view illustrating the second search window set in Step S153 illustrated in FIG. 7.

Next, the control unit 53 generates the plurality of (nine in the embodiment) reference points used in performing the calibration (Step S20 or Step S24) (to be described later). Hereinafter, the calibration will be described with reference to the flowchart illustrated in FIG. 7. The number of reference points 305 may be at least three or more, and the number thereof may be optionally determined. However, as the number of the reference points 305 increases, the accuracy of the calibration is improved.

### Positioning of the Marker at the Center of the First Search Window (FIG. 7: Step S151)

The control unit 53 drives the robot arm 10 so as to position the marker 61 at the center O301 of the first search window 301 set in the captured image 30 illustrated in FIG. 8. The first search window 301 indicates a predetermined range on the captured image 30 designated by the worker, and is used for generating the plurality of reference points 305. In the embodiment, the first search window 301 and the captured image 30 coincide with each other. The center O301 of the first search window 301 and the center O30 of the captured image 30 coincide with each other.

Determination of Whether or not the Object Falls within the First Region (FIG. 7: Step S152)

The control unit 53 recognizes the image of the object 60, and determines whether or not the object 60 falls within one of first regions S1 obtained by equally dividing the first search window 301 into nine regions. In the embodiment, the image of the object 60 is recognized (detected) by recognizing an outer shape (for example, four corner portions) of the object 60. A method of recognizing the image is not limited to the method of recognizing the four corner portions of the object 60, and any method may be used. For example, it is an effective way to recognize the object 60 by acquiring a value of a rotation angle of the object 60 with respect to a model (template) of the outer shape registered in advance. The object 60 may be not only a substance but also a model window for detecting a substance.

A Case where the Object Falls within the First Region (FIG. 7: Step S152, Yes)

In a case of falling within the first region S1 as in an object 60b (object 60) illustrated in FIG. 8, the process proceeds to Step S156.

### Generation of the Plurality of Reference Points (FIG. 7: Step S156)

The control unit 53 sets the center point of each first region S1 of the first search window 301 as the reference point 305 to be used for the calibration (refer to FIG. 8). In the embodiment, nine reference points 305 arrayed in a lattice pattern are set, and the distance (Δxb and Δyb) between the reference point 305 and the center O301 in the image coordinate system is obtained. The movement amount (Δxa and Δya) in the distal coordinate system corresponding to the distance (Δxb and Δyb) in the image coordinate system is obtained using the coordinate transformation equation obtained in Step S14 described above. In this manner, if the center O301 of the first search window 301 is taught, the remaining eight reference points 305 can be automatically generated. Therefore, for example, each location is taught by actually performing so-called jog feeding on nine places. In this manner, it is possible to save time and labor in setting the nine reference points 305. Therefore, it is possible to minimize artificial errors in setting each reference point 305, and it is possible to shorten a time required for setting the plurality of reference points 305.

In the embodiment, the center point of the first region S1 is set as the reference point 305. However, the reference point 305 is not limited to the center point of the first region S1. Any location may be used as long as the location falls within the first region S1.

A Case where the Object does not Fall within the First Region (FIG. 7: Step S152, No)

In a case of not falling within the first region S1 as in an object 60a (object 60) illustrated in FIG. 8, the process proceeds to Step S153.

### Setting of a Second Search Window (FIG. 7: Step S153)

In view of a region (protruding portion) in which the object 60a does not fall within the first region S1, the control unit 53 sets a second search window 302 smaller than the first search window 301 (refer to FIGS. 8 to 10).

Here, in performing the calibration (Step S20 or Step S24) (to be described later), work is carried out for moving the mobile camera 3 to nine locations so that one marker 61 is positioned (appears) at each reference point 305 or each reference point 306 (to be described later) on the captured image 30. In this case, if the object 60a does not fall within the first region S1, a portion of the object 60a cannot appear within the captured image 30 as in the object 60a illustrated by a broken line in FIG. 8. Therefore, the image of the object 60a cannot be recognized, and the calibration cannot be accurately performed in some cases. Therefore, the second search window 302 is set to be smaller than the first search window 301, and the reference point 305 (to be described later) is set based on the second search window 302. That is, the reference point 305 is set so that the calibration can be performed while the image of the object 60a is recognized.

Specifically, first, the control unit 53 calculates A, B, C, and D illustrated below as information relating to the first region S1 (refer to FIG. 9).

$$A = \frac{sw\_width}{6}$$

$$B = \frac{sw\_width}{6}$$

$$C = \frac{sw\_Height}{6}$$

$$D = \frac{sw\_Height}{6}$$

“A” represents a length from the center point of the first region S1 to an edge on the −xb side. “B” represents a length from the center point of the first region S1 to an edge on the +xb side. “C” represents a length from the center point of the first region S1 to an edge on the +yb side. “D” represents a length from the center point of the first region S1 to an edge of −yb side.

Next, the control unit 53 uses the following equation (matrix) as the information of the object 60 in the image coordinate system so as to calculate respective image coordinates of E, F, G, H, and FP.

$$( \begin{matrix}xb \\ yb\end{matrix} ) = ( \begin{matrix}cos θ & - sin θ \\ sin θ & cos θ\end{matrix} ) ( \begin{matrix}xa \\ ya\end{matrix} )$$

E=(0,0)

F=(MW·cos θ,MW·sin θ)

G=(MH·(−sin θ),MH·cos θ)

H=(MW·cos θ+MH·(−sin θ),MW·sin θ+MH·cos θ)

FP=(MOX·cos θ+MOY·(−sin θ),MOX·sin θ+MOY·cos θ)

As illustrated in FIG. 9, “E”, “F”, “G”, and “H” represent image coordinates of corners of the object 60. As illustrated in FIG. 9, “FP” represents an image coordinate of the center of the marker 61 (marker recognition position) in the captured image 30.

The control unit 53 calculates A′, B′, C′, and D′ illustrated below as the information of the object 60 on the captured image 30, based on A to D, E to H, and FP.

A′=(0301_,xb)−(G_xb)

B′=(F_xb)−(0301_xb)

C′=(H_yb)−(0301_yb)

D′=(0301_yb)−(E_yb)

“A′” represents the length in the xb-direction from the marker 61 to G in the object 60 on the captured image 30. “B′” represents the length in the xb-direction from the marker 61 to F in the object 60 on the captured image 30. “C′” represents the length in the yb-direction from the marker 61 to H in the object 60 on the captured image 30. “D′” represents the length in the yb-direction from the marker 61 to E in the object 60 on the captured image 30.

Next, as illustrated in FIG. 10, the control unit 53 sets the second search window 302 so that the first search window 301 is made small as much as a region which does not fall within the first region S1 of the object 60. More specifically, as illustrated in FIG. 10, the position of the edge on the −xb side of the first search window 301 is set to be closer to the center by (A′-A″). The position of the edge on the +yb side of the first search window 301 is set to be closer to the center by (C′-C″). The position of the edge on the −yb side of the first search window 301 is set to be closer to the center by (D′-D″). In the embodiment, a portion of the object 60 positioned on the +xb side from the center point of the first region S1 falls within the first region S1. Accordingly, the position of the edge on the +xb side of the first search window 301 is not changed.

The above-described “A” represents the length from the center point to the edge on the −xb side of the second region S2, which is obtained by equally dividing the second search window 302 into nine regions. “C” represents the length from the center point to the edge on the +yb side of the second region S2. “D” represents the length from the center point to the edge on the −yb side in the second region S2. In this manner, the second search window 302 can be set.

In this way, the control unit 53 calibrates the first search window 301, based on the information relating to the first region S1 obtained by dividing the first search window 301 set in the captured image 30 and the information of the object 60 having the marker 61 appearing in the captured image 30. In this manner, the control unit 53 sets the second search window 302, and sets the plurality of reference points 305, based on the second search window 302. In this manner, the image of the object 60 can be properly recognized when the calibration is performed. Accordingly, mapping can be more accurately performed between the image coordinate system and the distal coordinate system. According to the method of setting the second search window, the reference point 305 can be set by causing the control device 5 to automatically set the second search window.

### Positioning of the Marker at the Center of the Second Search Window (FIG. 7: Step S154)

Next, the control unit 53 drives the robot arm 10 so as to position the marker 61 at the center O302 of the second search window 302.

### Moving the Predetermined Portion of the Robot to Two Locations, and Resetting the Coordinate Transformation Equation (FIG. 7: Step S155)

Next, similarly to Step S13, in a state where the marker 61 is positioned at the center O302 of the second search window 302, the control unit 53 moves the predetermined portion (in the embodiment, the axis coordinate P2) of the robot 1 to two locations different therefrom. The storage unit 55 stores each of the robot coordinates (xa and ya) and the image coordinates (xb and yb) in a state where the marker 61 is positioned at the center O302 and when the marker 61 is moved to the two locations different therefrom.

Next, the coordinate transformation equation (primary transformation matrix) is generated (reset) using the method the same as that in Step S14. That is, the coordinate transformation equation obtained in Step S14 is updated.

Here, in Step S13, the movement amount from the point A0 to the points A1 and A2 in Step S13 is very small. The reason that the movement amount is small is that in Step S13, a relationship (how long the angle of view is in the robot coordinate system in units of mm) is unknown between the movement amount (size) in the image coordinate system and the movement amount (size) in the robot coordinate system. Accordingly, the reason is to prevent the marker 61 from not appearing in the captured image 30 when the marker 61 is moved. As described above, the coordinate transformation equation obtained in Step S14 is calculated by moving the marker 61 to a short distance. Consequently, in some cases, the movement amount is inaccurately calculated. In contrast, if the coordinate transformation equation is generated once, the relationship can be roughly recognized between the movement amount (size) in the image coordinate system and the movement amount (size) in the robot coordinate system. Therefore, in Step S155, since the coordinate transformation equation is generated in Step S13, the marker 61 can be further moved within the range (within the angle of view) in which the marker 61 appears in the captured image 30 so that the movement amount in Step S155 is larger than the movement amount in Step S13. That is, the movement amount in Step S155 can be further increased than the movement amount in Step S13. In this manner, in Step S155, the more accurate coordinate transformation equation can be obtained compared to the coordinate transformation equation obtained in Step S14.

### Generation of the Plurality of Reference Points (FIG. 7: Step S156)

Next, in the same way as the generation of the reference point based on the first search window 301 described above, the control unit 53 sets (generates) the center point of each second region S2 of the second search window 302 as the plurality of reference points 305 arrayed in a lattice pattern to be used for the calibration (refer to FIG. 10). In this way, the control unit 53 sets the plurality of reference points 305, based on the second region S2 obtained by dividing the second search window 302. In this manner, the plurality of reference points 305 can be easily set. That is, if the center O302 of the second search window 302 is taught, the remaining eight reference points 305 can be automatically generated. Therefore, for example, each location is taught by actually performing so-called jog feeding on nine places. In this manner, it is possible to save time and labor in setting the nine reference points 305. Therefore, it is possible to minimize artificial errors in setting each reference point 305, and it is possible to shorten a time required for setting the plurality of reference points 305.

### Resetting of the Plurality of Reference Points (FIG. 4: Step S16)

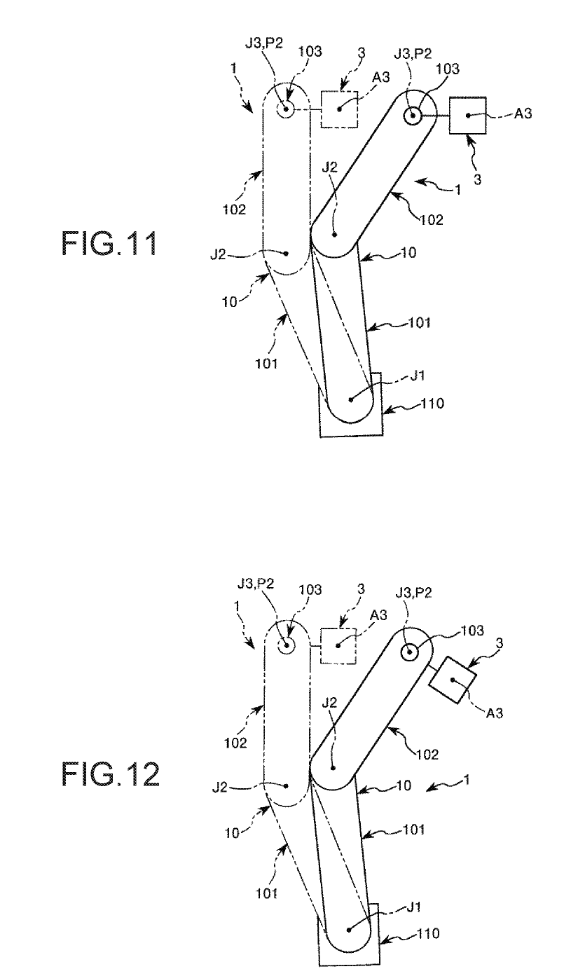

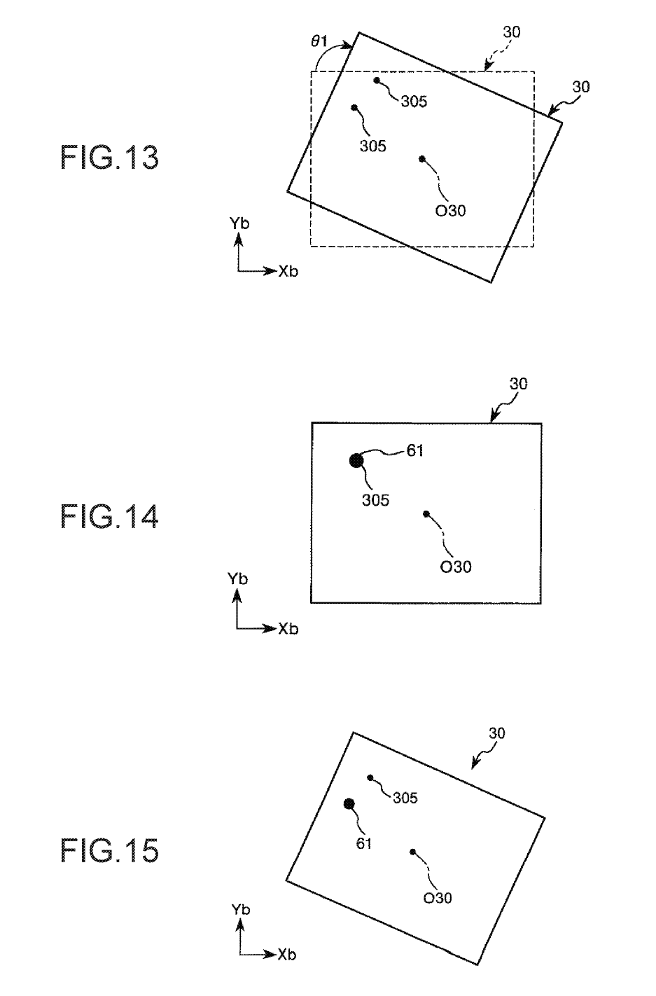

FIGS. 11 and 12 are schematic diagrams of the robot for respectively describing Step S16 illustrated in FIG. 4. FIGS. 13, 14, 15, and 16 are views illustrating the captured image for describing Step S16 illustrated in FIG. 4.

Next, the control unit 53 updates the coordinate transformation equation obtained in Step S14 in view of the pivoting (driving) of the mobile camera 3 in response to the pivoting (driving) of the second arm 102, and resets (calibrates) the nine reference points 305 (Step S16). That is, the coordinate transformation equation is updated so as to generate new nine reference points 306.

Here, as described above, the robot 1 has the first arm 101 pivoting around the first axis J1 along the perpendicular direction, the second arm 102 pivoting around the second axis J2 along the perpendicular direction, and the spline shaft 103 pivoting around the third axis J3 along the perpendicular direction (refer to FIG. 1). That is, the robot 1 has the first arm 101, the second arm 102, and the spline shaft 103 which serve as three members capable of pivoting around a yaw axis with respect to the base 110. As described above, the optical axis A3 of the mobile camera 3 is disposed so as to extend along (be parallel to) the first axis J1, the second axis J2, and the third axis J3.

For example, in a case where the mobile camera 3 is attached to the spline shaft 103 pivoting around the third axis J3 located third from the base 110, without changing a posture of the mobile camera 3 as illustrated in FIG. 11, the mobile camera 3 can be moved. That is, the mobile camera 3 can have the same posture both in a state of the robot 1 indicated by the two-dot chain line in FIG. 11 and in a state of the robot 1 indicated by the solid line in FIG. 11. The reason is that the spline shaft 103 is caused to pivot around the third axis J3 so as to pivot the mobile camera 3 in response to the pivoting of the spline shaft 103.

In contrast, as in the embodiment, in a case where the mobile camera 3 is attached to the second arm 102 pivoting around the second axis J2 located second from the base 110, the mobile camera 3 pivots in response to the pivoting of the second arm 102 as illustrated in FIG. 12. That is, the postures of the mobile camera 3 are different from each other both in the state of the robot 1 indicated by the two-dot chain line in FIG. 12 and in the state of the robot 1 indicated by the solid line in FIG. 12. In this way, if the mobile camera 3 pivots in response to the pivoting of the second arm 102, a frame of the captured image 30 pivots accordingly (refer to FIG. 13). Therefore, even if the axis coordinate P2 is moved so that the marker 61 is positioned at one reference point 305, based on the relative relationship between the distal coordinate system and the image coordinate system which are obtained in Step S14, the reference point 305 is misaligned with the marker 61 appearing in the captured image 30 due to the change in the posture of the frame (refer to FIG. 15). That is, even if the axis coordinate P2 is moved so that the marker 61 is positioned at one reference point 305 as illustrated in FIG. 14, one reference point 305 and the marker 61 are misaligned with each other as illustrated in FIG. 15.

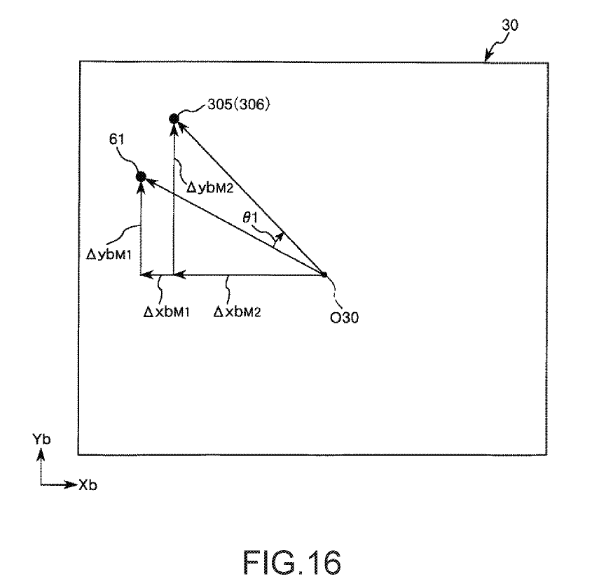

Therefore, in Step S16, the coordinate transformation equation is updated in view of the pivoting in response to the pivoting of the second arm 102 of the mobile camera 3. Specifically, the displacement (Δxb_{M1} and Δyb_{M1}) between the center O30 of the captured image 30 and the marker 61 on the captured image 30, and the displacement (Δxb_{M1} and Δyb_{M1}) between the center O30 and the reference point 305 are calculated using the coordinate transformation equation obtained in Step S14 described above. Based on the displacements and Equation (2) below, the control unit 53 resets (calibrates) a new reference point 306 (refer to FIG. 16).

$$( \begin{matrix}Δ xb \\ Δ yb\end{matrix} ) = ( \begin{matrix}cos θ & - sin θ \\ sin θ & cos θ\end{matrix} ) ( \begin{matrix}Δ xa \\ Δ ya\end{matrix} ) \qquad ( 2 )$$

In this way, the new reference point 306 is reset (calibrated) in view of the pivoting of the mobile camera 3 in response to the pivoting (movement) of the second arm 102. In this manner, as in the embodiment, even in a case where the mobile camera 3 is attached to the second arm 102, the marker 61 can be properly positioned at the reference point 306. Accordingly, the calibration (Step S20 or Step S24) can be more accurately performed (to be described later).

### Calculation of an Offset of the Mobile Camera 3 (FIG. 4: Step S17)

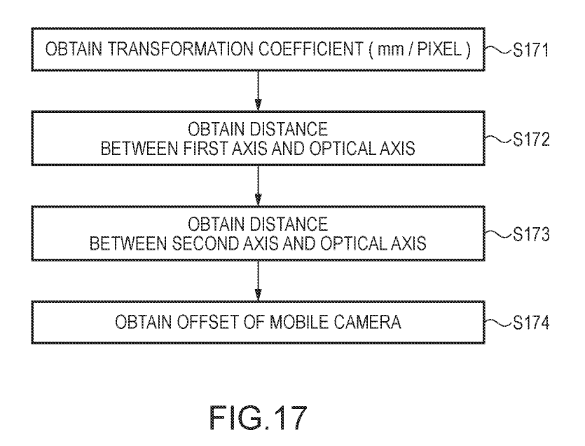

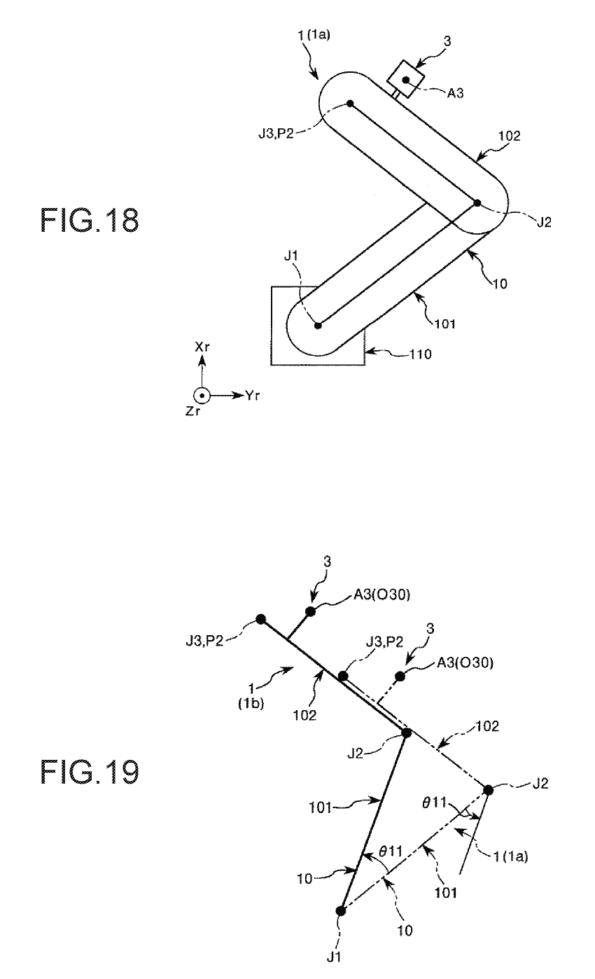

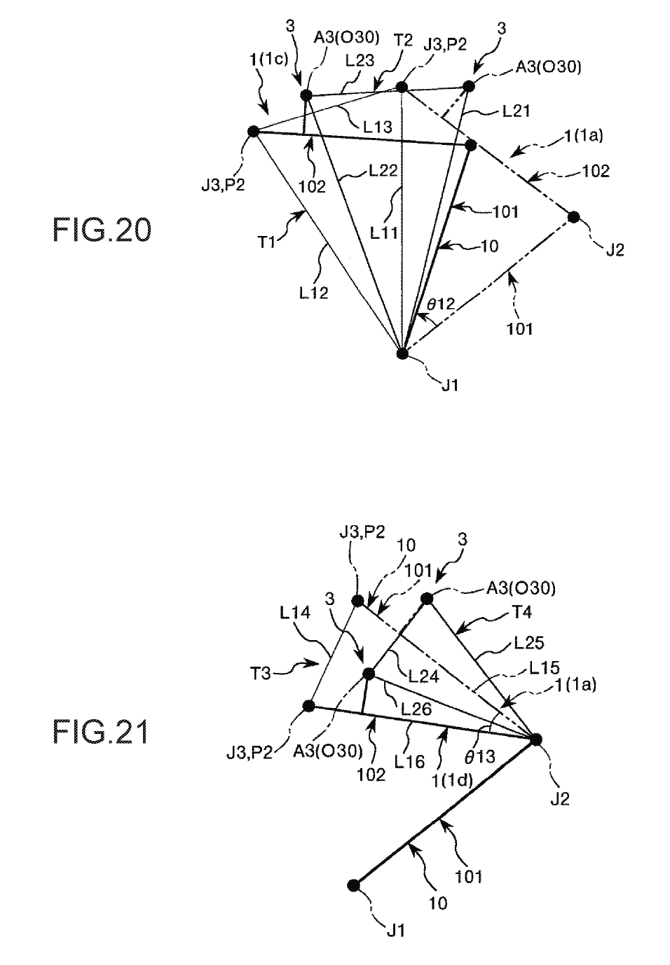

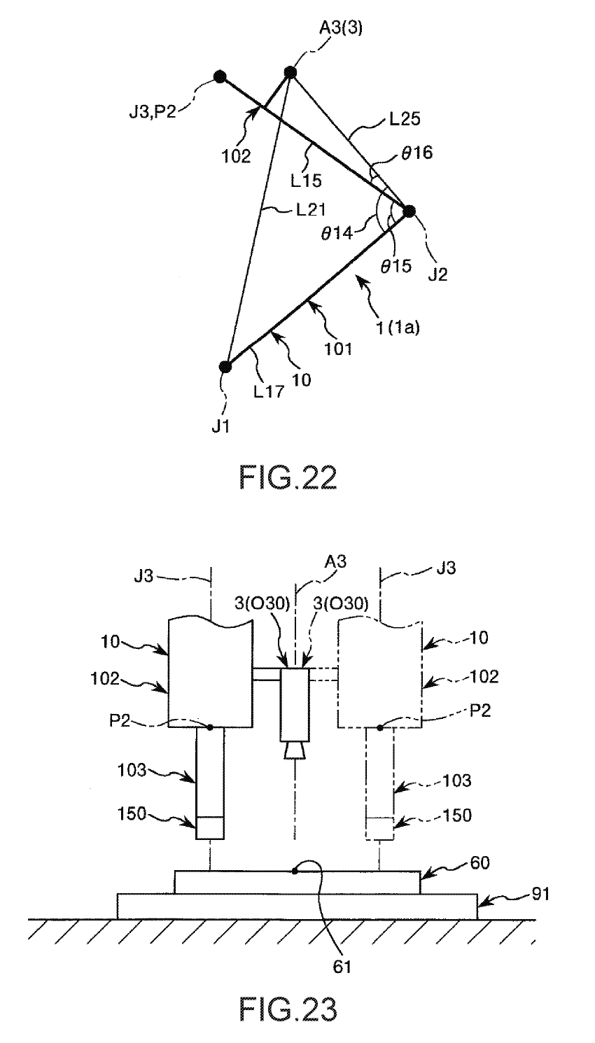

FIG. 17 is a flowchart for describing Step S17 illustrated in FIG. 4. FIG. 18 is a schematic view of the robot for describing Step S171 illustrated in FIG. 17. FIG. 19 is a schematic view of the robot for describing Step S171 illustrated in FIG. 17. FIG. 20 is a schematic view of the robot for describing Step S172 illustrated in FIG. 17. FIG. 21 is a schematic view of the robot for describing Step S173 illustrated in FIG. 17. FIG. 22 is a schematic view of the robot for describing Step S174 illustrated in FIG. 17.

Next, the control unit 53 calculates the offset of the mobile camera 3 (arm setting at the installation position of the mobile camera 3). In the embodiment, the control unit 53 obtains the misalignment of the position of the marker 61 appearing in the captured image 30 with the axis coordinate P2, that is, the distance between the axis coordinate P2 and the marker 61 appearing in the captured image 30 in the translation components xa and ya with respect to two axes excluding the axis parallel to the third axis J3. More specifically, in the embodiment, the control unit 53 obtains the distance between the optical axis A3 of the mobile camera 3 and the second axis J2 in the horizontal plane (viewed in the direction extending along the second axis J2), and how much degrees (°) the optical axis A3 of the mobile camera 3 is misaligned with the second arm 102 (line segment connecting the second axis J2 and the third axis J3 to each other) around the second axis J2. Hereinafter, this will be described with reference to the flowchart illustrated in FIG. 17.

### Obtaining a Transformation Coefficient (Mm/Pixel: Resolution) (FIG. 17: Step S171)

First, in a state of a robot 1a (robot 1) illustrated in FIG. 18, the control unit 53 drives the robot arm 10 so as to change the position of the mobile camera 3 without changing the posture of the mobile camera 3 as illustrated in FIG. 19 from the state of the robot 1a (the robot 1), and obtains the transformation coefficient (mm/pixel), based on the image coordinates and the robot coordinates before and after the position is changed.

Specifically, the control unit 53 changes the state of the robot 1a illustrated by the two-dot chain line in FIG. 19 to a state of a robot 1b (robot 1) illustrated by the solid line in FIG. 19. This change can be realized by pivoting the first axis J1 counterclockwise at an angle +θ11 (°) and pivoting the second axis J2 clockwise at an angle −θ11 (°). The control unit 53 obtains the transformation coefficient (mm/pixel) of the image coordinates and the robot coordinates, from the movement distance (mm) of the axis coordinate P2 before and after the position of the mobile camera 3 is changed, that is, the movement distance (mm) of the mobile camera 3 and the movement distance (pixel) of the marker 61 appearing on the captured image 30.

### Obtaining the Distance Between the First Axis J1 and the Optical Axis A3 (FIG. 17: Step S172)

Next, the control unit 53 pivots the first axis J1 as illustrated in FIG. 20 so as to obtain a line segment L21 which represents the distance between the first axis J1 and the optical axis A3.

Specifically, the control unit 53 changes the state of the robot 1a illustrated by the two-dot chain line in FIG. 20 to a state of a robot 1c (robot 1) illustrated by the solid line in FIG. 20. This change can be realized by pivoting the first axis J1 at an angle θ12 (°) without pivoting the second axis J2.

The line segment L21 which represents the distance between the first axis J1 and the optical axis A3 is obtained as follows. A length (mm) of a line segment L11 connecting the first axis J1 and the axis coordinate P2 of the robot 1a to each other, a length (mm) of a line segment L12 connecting the first axis J1 and the axis coordinate P2 of the robot 1c to each other, and a length (mm) of a line segment L13 connecting the position of the axis coordinate P2 of the robot 1a and the position of the axis coordinate P2 of the robot 1c to each other are respectively known. A length (pixel) of a line segment L23 connecting the position of the center O30 of the captured image 30 of the robot 1a and the position of the center O30 of the captured image 30 of the robot 1c to each other is known. Therefore, the length (mm) of the line segment L23 in the distal coordinate system is obtained using the transformation coefficient (mm/pixel) obtained in Step S171. A triangle T1 configured to include the line segments L11, L12 and L13 and a triangle T2 configured to include the line segments L21, L22 and L23 are similar to each other. Since the triangle T1 and the triangle T2 are similar to each other, it is possible to obtain the length (mm) of the line segment L21 in the distal coordinate system from the line segments L11, L12, L13 and the line segment L23. The line segment L21 connects the first axis J1 and the optical axis A3 of the robot 1a to each other. The line segment L22 connects the first axis J1 and the optical axis A3 of the robot 1c to each other.

### Obtaining the Distance Between the Second Axis J2 and the Optical Axis A3 (FIG. 17: Step S173)

The control unit 53 pivots the second axis J2 as illustrated in FIG. 21 so as to obtain a line segment L25 which represents the distance between the second axis J2 and the optical axis A3.

Specifically, the control unit 53 changes the state of the robot 1a illustrated by the two-dot chain line in FIG. 21 to a state of a robot 1d (robot 1) illustrated by the solid line in FIG. 21. This change can be realized by pivoting the second axis J2 at an angle θ13 (°) without pivoting the first axis J1.

The line segment L25, which represents the distance between the second axis J2 and the optical axis A3 is obtained as follows. The length (mm) of the line segment L15 connecting the second axis J2 of the robot 1a and the axis coordinate P2 to each other, the length (mm) of the line segment L16 connecting the second axis J2 and the axis coordinate P2 of the robot 1d to each other, and the length (mm) of the line segment L14 connecting the position of the axis coordinate P2 of the robot 1a and the position of the axis coordinate P2 of the robot 1d to each other are respectively known. The length (pixel) of the line segment L24 connecting the position of the center O30 of the captured image 30 of the robot 1a and the position of the center O30 of the captured image 30 of the robot 1d to each other is known. Therefore, the length (mm) of the line segment L24 in the distal coordinate system is obtained using the transformation coefficient (mm/pixel) obtained in Step S171. A triangle T3 configured to include the line segments L14, L15, and L16 and a triangle T4 configured to include the line segments L24, L25, and L26 are similar to each other. Since the triangle T3 and the triangle T4 are similar to each other, it is possible to obtain the length (mm) of the line segment L25 in the distal coordinate system from the line segments L14, L15, and L16 and the line segment L24. The line segment L25 connects the second axis J2 of the robot 1a and the optical axis A3 to each other. The line segment L26 connects the second axis J2 and the optical axis A3 of the robot 1d to each other.

### Obtaining an Offset of the Mobile Camera 3 (FIG. 17: Step S174)

Next, the control unit 53 uses Equation (3) below so as to calculate an angle θ14 formed between the line segment L17 and the line segment L25 from the line segment L25 connecting the second axis J2 and the optical axis A3 of the robot 1a to each other, the line segment L17, and the line segment L21 (refer to FIG. 22).

$$θ 14 = arccos ( \frac{{( L 25 )}^{2} + {( L 17 )}^{2} - {( L 21 )}^{2}}{2 \cdot L 25 \cdot L 17} ) \qquad ( 3 )$$

An angle θ16 formed between the line segment L15 and the line segment L25 is obtained from the obtained angle θ14 and an angle θ15 formed between the known line segment L15 and line segment L17. In this way, it is possible to obtain that the mobile camera 3 is installed at a position misaligned at an angle θ16 (°) around the second axis J2 in the horizontal plane with respect to the second arm 102.

Through the above-described configuration, the offset of the mobile camera 3 can be automatically obtained by the control device 5.

In calculating the offset of the mobile camera 3 described above (Step S17), the control unit 53 drives the robot arm 10 serving as the “movable unit” so as to move the mobile camera 3 serving as the “imaging unit” to at least two locations (two locations in the embodiment) without changing the posture of the mobile camera 3 serving as the “imaging unit”. Based on coordinates (image coordinates) in the image coordinate system serving as the “coordinate system of the imaging unit” in at least two locations and coordinates (robot coordinates) in the distal coordinate system serving as the “coordinate system of the robot” in at least two locations, the control unit 53 calculates the transformation coefficient (mm/pixel) of the image coordinate system and the distal coordinate system (Step S171). The control unit 53 calculates the offset of the mobile camera 3 serving as the “imaging unit” with respect to the second arm 102 serving as the “arm” having the mobile camera 3 serving as the “imaging unit”. In this way, the mobile camera 3 is moved (particularly, translated) without changing the posture of the mobile camera 3. Through this configuration, the misalignment of the position of the mobile camera 3 with the robot arm 10 (second arm 102 in the embodiment), that is, the offset is calculated. In this manner, the transformation coefficient can be relatively easily obtained. The transformation coefficient is used so that the offset can be easily obtained in a short time.

Here, the term of translation means linearly moving within a plane (excluding rotation and arc-shaped movement). The term of changing the posture of the mobile camera 3 (imaging unit) means changing at least one of the components ub, vb, and wb. The term of changing the position of the mobile camera 3 (imaging unit) means changing at least one of the components xb, yb, and zb. The term of without changing the posture of the mobile camera 3 (imaging unit) means without changing the components ub, vb, and wb.

In calculating the offset in Step S17, it is possible to use an optimized calculation method according to a third embodiment (to be described later) instead of Step S172 to Step S174.

### Positioning of the Marker at the Center of the Captured Image (FIG. 4: Step S18)

Next, the control unit 53 drives the robot arm 10 so as to position the marker 61 at the center O30 of the captured image 30.

### Determination of Whether or not to Perform an Operation for Changing the Posture of the Hand (FIG. 4: Step S19)

Next, the control unit 53 determines whether or not to perform the operation for changing the posture of the hand 150.

### A Case of Performing the Operation for Changing the Posture of the Hand (Step S19: Yes)

In a case of performing the operation for changing the posture of the hand 150, the process proceeds to Step S21.

### Starting to Perform the Operation for Changing the Posture of the Hand (FIG. 4: Step S21)

The control unit 53 starts performing the operation for changing the posture of the hand 150. The operation for changing the posture of the hand 150 means an operation for changing the posture of the hand 150 so as to change the posture of the mobile camera 3 without causing the mobile camera 3 to change an imaging position. The operation for changing the posture of the hand 150 is performed. In this manner, it is possible to obtain the more accurate offset by updating the above-described offset.

Change of the Posture of the Hand from a First Hand Posture to a Second Hand Posture while Positioning the Marker at the Center of the Captured Image (FIG. 4: Step S22)

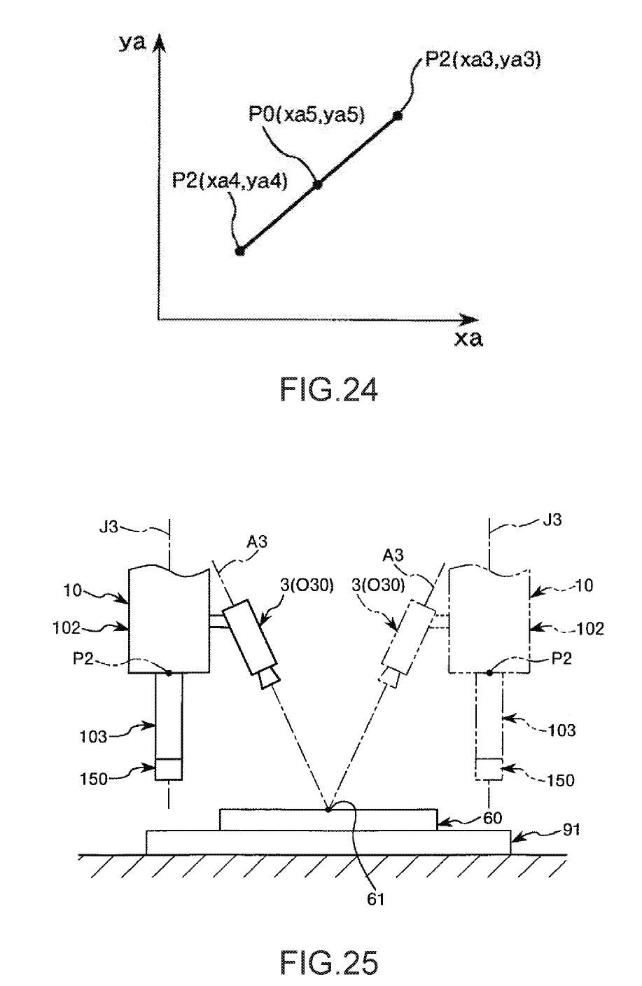

FIG. 23 is a schematic view of the robot for describing Step S22 illustrated in FIG. 4. FIG. 24 is a view illustrating the robot coordinates for describing Step S22 illustrated in FIG. 4. FIG. 25 is a schematic view of the robot for describing Step S22 illustrated in FIG. 4.

Here, in Step S18 described above, a state of the distal portion of the robot arm 10 when the marker 61 is positioned at the center O30 of the captured image 30 is indicated by the two-dot chain line in FIG. 23. The posture of the hand 150 at this time is referred to as a “first hand posture”.

First, the control unit 53 drives the robot arm 10 while positioning the marker 61 at the center O30 of the captured image 30, and changes the posture (first posture) of the hand 150 illustrated by the two-dot chain line in FIG. 23 to the posture (second posture) of the hand 150 illustrated by the solid line in FIG. 23. Specifically, for example, first, the control unit 53 brings the robot arm 10 into a state of a so-called right arm posture, and positions the marker 61 at the center O30 of the captured image 30. Next, the control unit 53 brings the robot arm 10 into a state of a so-called left arm posture, and positions the marker 61 at the center O30 of the captured image 30. Here, according to the configuration of the robot 1, the posture of the robot arm 10 which can be adopted in a state where one marker 61 is positioned at the center O30 of the captured image 30 is limited to two postures of the right arm posture and the left arm posture. Therefore, depending on the position where the marker 61 is installed (where the marker 61 is installed in the base coordinate system), it is determined how many degrees the hand 150 can be rotated around a perpendicular line passing through the marker 61 with the right arm posture and the left arm posture. In the embodiment, for example, if the state of the left arm posture is set after the right arm posture as described above, the hand 150 (axis coordinate P2) is brought into a state where the hand 150 moves to a position different by 180° around the perpendicular line passing through the marker 61 (refer to FIG. 24).

Next, as illustrated in FIG. 24, the control unit 53 calculates the robot coordinates (xa5 and ya5) at the intermediate point P0 between the robot coordinates (xa3 and ya3) of the axis coordinate P2 when the hand 150 adopts the first hand posture and the robot coordinates (xa4 and ya4) of the axis coordinate P2 when the hand 150 adopts the secondhand posture. For example, the control unit 53 obtains the distance between the robot coordinates of the axis coordinate P2 and the robot coordinates of the intermediate point P0 in the first hand posture, and sets the distance as the offset of mobile camera 3 with respect to the second arm 102.

In the embodiment, the offset of the mobile camera 3 is obtained by pivoting the hand 150 and the mobile camera 3 around the perpendicular line passing through the marker 61 by 180°. However, without being limited to 180°, the angle may be optionally set. Even in a case where the angle is other than 180°, the distance between the axis coordinate P2 and the marker 61 in the horizontal plane, the rotation angle around the perpendicular line passing through the marker 61 from the right arm posture to the left arm posture, the robot coordinates of the axis coordinate P2 in the first posture, the robot coordinates of the axis coordinate P2 in the second posture, and the image coordinates of the marker 61 are used, and simultaneous equations are solved. In this manner, the robot coordinates of the marker 61 can be obtained. For example, the offset of the mobile camera 3 can be obtained by obtaining the distance between the robot coordinates of the axis coordinate P2 and the robot coordinates of the marker 61 in the first hand posture.

In this way, the control unit 53 drives the robot arm 10 serving as the “movable unit” so as to change the posture of the mobile camera 3 serving as the “imaging unit” without causing the mobile camera 3 serving as the “imaging unit” to change the imaging position. Based on the coordinates (robot coordinates) in the distal coordinate system serving as the “coordinate system of the robot” before and after the posture of the mobile camera 3 is changed, the control unit 53 updates the offset. That is, a new offset is obtained, based on the offset obtained in Step S17 and the offset obtained by changing the posture in Step S22. In this manner, it is possible to obtain the more accurate offset of the mobile camera 3 (more specifically, the misalignment of the position of the marker 61 appearing in the captured image 30 with respect to the axis coordinate P2). The term of changing the posture of the mobile camera 3 described above indicates changing the component ub (refer to FIG. 23).

Here, for example, as described above, the mobile camera 3 is attached to the second arm 102 so that the optical axis A3 is parallel to the third axis J3 in design. However, in actual practice, the mobile camera 3 may be attached to the second arm 102 in a state where the optical axis A3 is inclined with respect to the third axis J3 due to an artificial attachment error of the mobile camera 3 (refer to FIG. 25). In this way, even if the optical axis A3 is inclined with respect to the third axis J3, the above-described operation for changing the posture of the hand 150 is performed. Accordingly, the offset can be calculated in view of the inclination of the optical axis A3.

### Resetting of the Hand to Adopt the First Hand Posture (Step S23)

Next, the control unit 53 resets the hand 150 to adopt the first posture, and the process proceeds to Step S24.

### Performing the Calibration (Step S24)

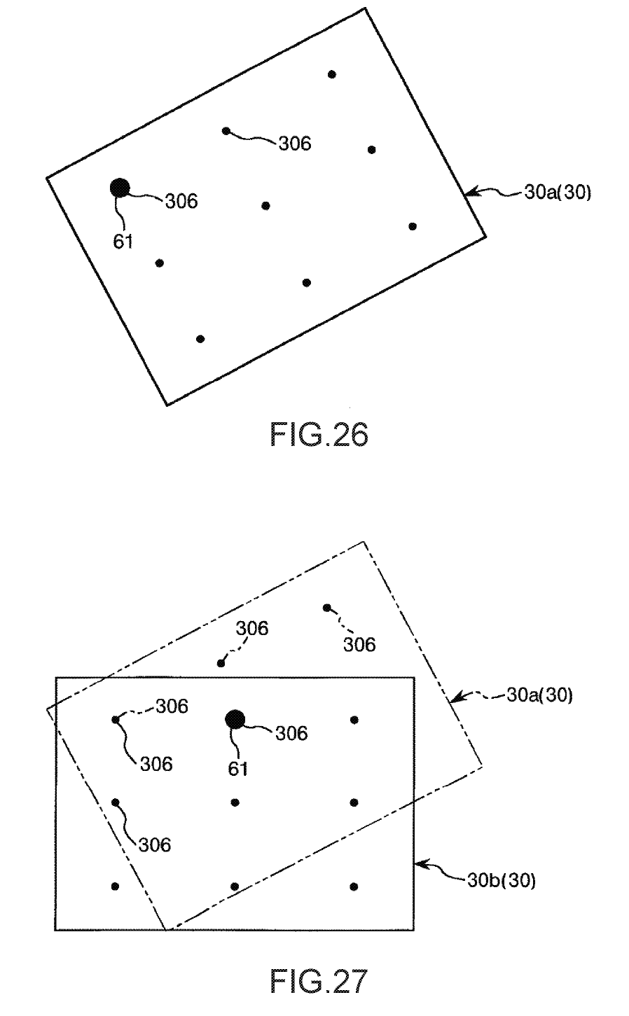

FIGS. 26 and 27 are views illustrating the captured images for respectively describing Step S24 illustrated in FIG. 4.

The control unit 53 uses each position of the plurality of reference points 306 obtained in Step S16 and the offset obtained in Steps S21 and S22, drives the robot arm 10, and moves the axis coordinate P2 and the mobile camera 3 so as to position the marker 61 at each reference point 306. At this time, every time the mobile camera 3 moves, the marker 61 is imaged by the camera 3 so as to acquire the image data.

For example, the control unit 53 drives the robot arm 10, and positions the mobile camera 3 so that the marker 61 is positioned at the first reference point 306 (refer to FIG. 26). The position of the mobile camera 3 at this time is set as a “first position”. The storage unit 55 stores a first captured image 30a (captured image 30) captured at this time. For example, the control unit 53 drives the robot arm 10, and positions the mobile camera 3 so that the marker 61 is positioned at the second reference point 306 (refer to FIG. 27). The position of the mobile camera 3 at this time is set as a “second position”. The storage unit 55 stores a second captured image 30b (captured image 30) captured at this time. In this way, the positions of the axis coordinate P2 and the mobile camera 3 are sequentially moved so as to acquire the captured image each time. That is, first to ninth captured images (image data) are acquired by positioning the mobile camera 3 at first to ninth positions.

Next, based on the coordinates (components xb, yb, and ub) of the marker 61 based on the first to ninth captured images and the robot coordinates (components xa, ya, and ua), the control unit 53 obtains calibration parameters (coordinate transformation matrix) for transforming the image coordinates into the robot coordinates. In this manner, the calibration is completed between the image coordinate system and the distal coordinate system. In this manner, as described above, the robot coordinate system and the base coordinate system are in a completely mapped. Accordingly, the mapping can be performed between the image coordinate system and the base coordinate system. In this way, the position (components xb and yb) and the posture (component ub) of the imaging target imaged by the mobile camera 3 can be transformed into the position (components xa and ya) and the posture (component ua) in the distal coordinate system. Therefore, the position (components xa and ya) of the marker 61 in the distal coordinate system can be obtained, based on the captured image 30. As a result, the hand 150 of the robot 1 can be positioned at the target location, based on the captured image 30.

In this way, the control unit 53 positions the mobile camera 3 serving as the “imaging unit” at the first position. The control unit 53 performs the mapping, based on the first captured image 30a obtained by causing the mobile camera 3 to image the marker 61 and the second captured image 30b obtained by causing the mobile camera 3 to image the marker 61 by positioning the mobile camera 3 at the second position different from the first position (refer to FIG. 27). As described above, the mobile camera 3 pivots in response to the pivoting of the second arm 102. Accordingly, the first posture of the mobile camera 3 at the first position and the second posture of the mobile camera 3 at the second position are different from each other. Therefore, as illustrated in FIG. 27, the frame of the first captured image 30a is in a state of pivoting with respect to the frame of the second captured image 30b. Here, in the embodiment, in Step S16, the reference point 306 is updated in view of the pivoting of the mobile camera 3. Therefore, even if the posture (first posture) of the mobile camera 3 at the first position is different from the posture (second posture) of the mobile camera 3 at the second position in this way, the calibration (mapping) can be more accurately performed.

A Case where the Operation for Changing the Posture of the Hand is not Performed (Step S19: No)

In a case where the operation for changing the posture of the hand 150 is not performed, the process proceeds to Step S20.

### Performing the Calibration (Step S20)

The calibration of the image coordinate system and the distal coordinate system is performed using the coordinate transformation equation obtained in Step S16 and the offset obtained in Step S17 and using the same method as that in Step S24.

In this way, the calibration is completed.

As described above, the control device 5 controls the robot 1 having robot arm 10 serving as the “movable unit” including the first arm 101, the second arm 102, and the spline shaft 103 which serve as a plurality of “arms”. The control device 5 includes the control unit 53 for performing the mapping between the coordinate system (image coordinate system) of the mobile camera 3 serving as the “imaging unit” disposed in the second arm 102 (arm) different from the spline shaft 103 (arm) positioned on the most distal side of the robot arm 10 serving as the “movable unit” and having the imaging function, and the coordinate system (distal coordinate system) of the robot 1. According to the control device 5 as described above, the mapping between the image coordinate system and the distal coordinate system, that is, the calibration can be performed as described above. Accordingly, based on the captured image 30 of the mobile camera 3, the robot 1 is enabled to carry out accurate work. According to the control device 5, the mapping can be performed in the mobile camera 3 disposed in the second arm 102 (arm) different from the spline shaft 103 (arm) positioned on the most distal side. Therefore, the control device 5 is used, thereby enabling the mobile camera 3 to be disposed in the second arm 102 (arm) of the robot 1. As a result, for example, it is possible to minimize a possibility that a wire (not illustrated) of the mobile camera 3 pulled from the base 110 of the robot 1 may be degraded after being frequently bent due to the rotation of the spline shaft 103.

In particular, as described above, the mobile camera 3 is disposed in the second arm 102 pivoting around the second axis J2 located second from the base 110 side in the first axis J1, the second axis J2, and the third axis J3 which are located in the pivoting direction the same as that of the optical axis A3 (yaw in the embodiment). According to the control device 5 of the embodiment, the mapping can be more precisely performed on the mobile camera 3 disposed in this location. Without being limited to the mobile camera 3 disposed in the second arm 102, any configuration may be adopted as long as the control device 5 can perform the mapping between the image coordinate system of the mobile camera 3 disposed in the arm other than the spline shaft 103 serving as the arm positioned in the most distal end of the robot arm 10 and the distal coordinate system of the robot 1. That is, the control device 5 can perform the mapping relating to the image coordinate system of the mobile camera 3 disposed in either the first arm 101 or the second arm 102.

The “coordinate system of the robot” is regarded as the distal coordinate system in the embodiment. However, the coordinate system of the robot may be regarded as the base coordinate system of the robot 1, or may be regarded as the coordinate system of the predetermined portion of the robot 1 other than the distal coordinate system. The “coordinate system of the imaging unit” indicates the coordinate system of the captured image output from the imaging unit. The “mapping” in the embodiment is regarded as the calibration of the image coordinate system and the robot coordinate system (distal coordinate system or base coordinate system). However, the mapping may be regarded as obtaining the relative relationship between the image coordinate system and the robot coordinate system as performed in Step S14. For example, the relative relationship means transforming the distance between two points in the image coordinate system into the distance between two points in the distal coordinate system.

As described above, the control unit 53 performs the mapping (performs the calibration), based on the captured image 30 (image data) obtained by causing the mobile camera 3 serving as the “imaging unit” to image the marker 61. In this manner, for example, it is unnecessary to touch up a calibration jig for the object 60. The mapping can be performed in the non-contact manner. Therefore, artificial variations of touch-up work can be reduced. Since the mapping can be performed in the non-contact manner, the mapping can be more accurately performed regardless of a material of the object, for example.

Here, in the embodiment, as the “marker”, the circular marker 61 attached to the object 60 is exemplified. However, any configuration may be adopted as long as the “the marker” is disposed at a location which enables the mobile camera 3 to image the “marker”. For example, without being limited to the circular marker 61, the “marker” may be a figure other than a circle, or a letter. A characteristic portion disposed in the object 60 or the object 60 itself may be used. Alternatively, the object 60 used in the calibration may have any shape.

Here, as described above, the robot 1 has the base 110 which supports the robot arm 10 serving as the “movable unit”. The second arm 102 (arm) different from the spline shaft 103 (arm) positioned on the most distal side of the robot arm 10 is capable of pivoting with respect to the base 110. The control unit 53 sets the plurality of reference points 305 to be used for the mapping, based on the captured image 30 (Step S15), calibrates the plurality of reference points 305 in view of the pivoting of the mobile camera 3 serving as the “imaging unit”, and updates the plurality of reference points 306 (Step S16). Specifically, in Step S16, the coordinate transformation equation is updated in view of the pivoting of the mobile camera 3, and the plurality of reference points 306 are reset. Therefore, in performing the calibration, even if the posture of the mobile camera 3 is changed at the first to ninth positions due to the pivoting of the mobile camera 3 in response to the pivoting of the second arm 102, the more accurate mapping can be realized between the image coordinate system and the distal coordinate system. Therefore, the mapping can be more accurately performed between the image coordinate system of the mobile camera 3 disposed in the second arm 102 and the distal coordinate system.

The above-described robot 1 is controlled by the control device 5, and has the robot arm 10 serving as the “movable unit” including the first arm 101, the second arm 102, and the spline shaft 103 which serve as the plurality of “arms”. According to the robot 1, under the control of the control device 5, the operation relating to the calibration (mapping) can be accurately performed.

Hitherto, the robot system 100 has been described. As described above, the robot system 100 includes the control device 5, the robot 1 controlled by the control device 5 and having the robot arm 10 serving as the “movable unit” including the first arm 101, the second arm 102, and the spline shaft 103 which serve as the plurality of “arms”, and the mobile camera 3 serving as the “imaging unit” having the imaging function. According to the robot system 100, the robot 1 can accurately perform the operation relating to the calibration (mapping) under the control of the control device 5. The mobile camera 3 can be attached to the second arm 102. Accordingly, for example, it is possible to minimize a possibility that a wire (not illustrated) of the mobile camera 3 pulled from the proximal side of the robot 1 may be degraded after being frequently bent due to the rotation of the spline shaft 103.

### Second Embodiment

Next, a second embodiment will be described.

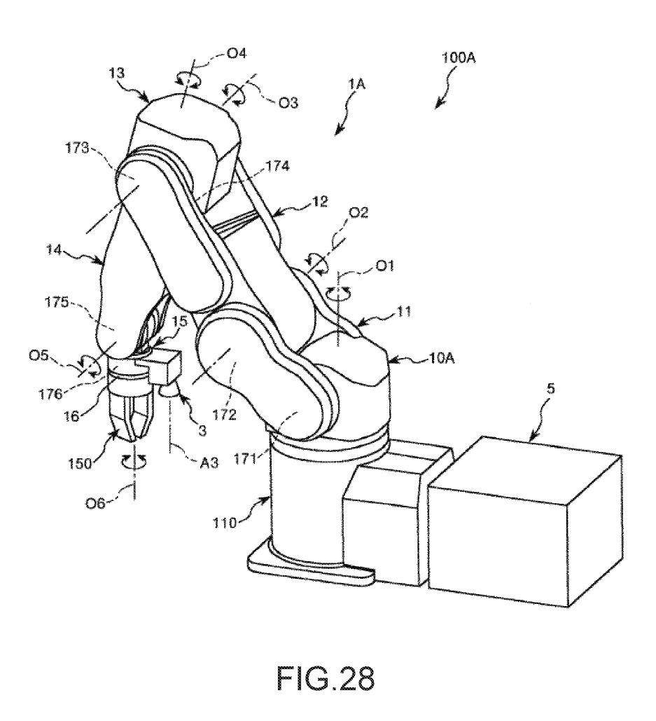

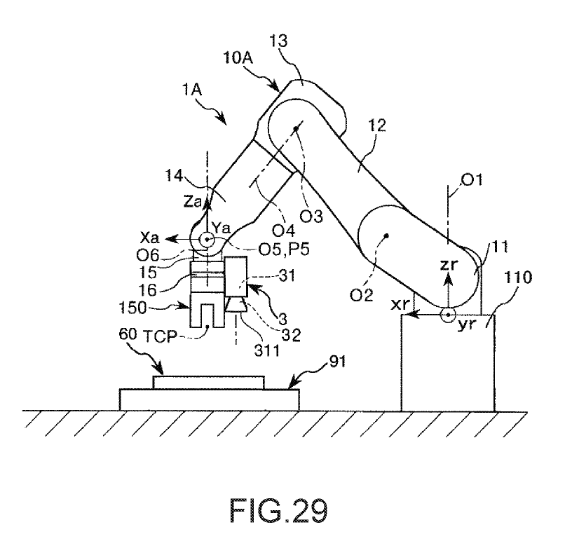

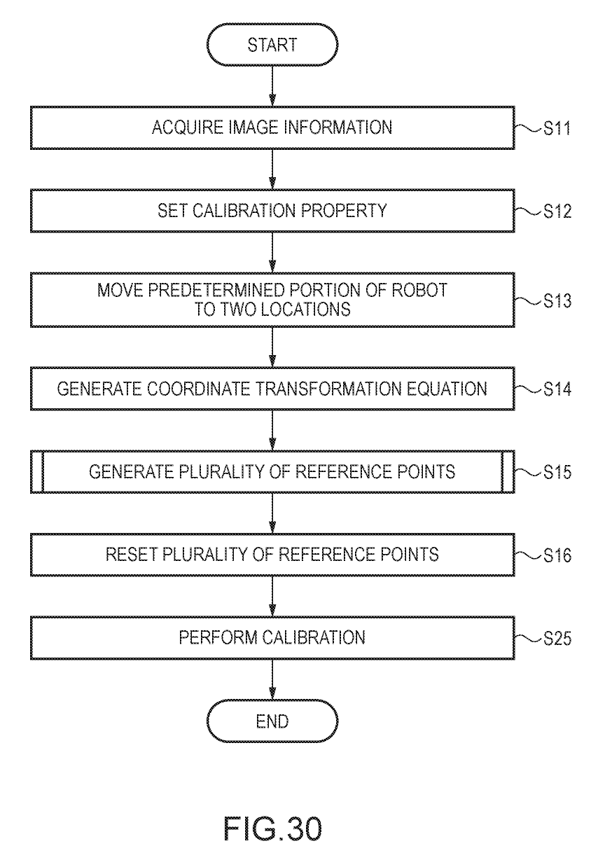

FIG. 28 is a perspective view of a robot system according to a second embodiment. FIG. 29 is a side view illustrating a robot belonging to the robot system illustrated in FIG. 28. FIG. 30 is a flowchart illustrating a flow of calibration performed by the robot system illustrated in FIG. 28.

The robot system according to the embodiment is mainly the same as that according to the above-described first embodiment except for the different configuration of the robot. In the following description, with regard to the second embodiment, points different from those of the above-described embodiment will be mainly described, and the same elements will be omitted in description.

### Robot

As illustrated in FIG. 28, a robot 1A of a robot system 100A is a so-called six-axis vertically articulated robot, and has a base 110 and a robot arm 10A.

As illustrated in FIG. 28, the robot arm 10A includes the first arm 11 (arm), a second arm 12 (arm), a third arm 13 (arm), and a fourth arm 14 (arm), a fifth arm 15 (arm), a sixth arm 16 (arm, distal arm), six joints 171 to 176 having a mechanism for supporting one arm so as to be pivotable with respect to the other arm (or the base 110), and the hand 150.

The base 110 and the first arm 11 are connected to each other via the joint 171, and the first arm 11 can pivot around a first pivot axis O1 along the perpendicular direction with respect to the base 110. The first arm 11 and the second arm 12 are connected to each other via the joint 172, and the second arm 12 can pivot around a second pivot axis O2 along the horizontal direction with respect to the first arm 11. The second arm 12 and the third arm 13 are connected to each other via the joint 173, and the third arm 13 can pivot around a third pivot axis O3 along the horizontal direction with respect to the second arm 12. The third arm 13 and the fourth arm 14 are connected to each other via the joint 174, and the fourth arm 14 can pivot around a fourth pivot axis O4 orthogonal to the third pivot axis O3 with respect to the third arm 13. The fourth arm 14 and the fifth arm 15 are connected to each other via the joint 175, and the fifth arm 15 can pivot around a fifth pivot axis O5 orthogonal to the fourth pivot axis O4 with respect to the fourth arm 14. The fifth arm 15 and the sixth arm 16 are connected to each other via the joint 176, and the sixth arm 16 can pivot around a sixth pivot axis O6 orthogonal to the fifth pivot axis O5 with respect to the fifth arm 15. Here, as illustrated in FIG. 29, an intersection between the fifth pivot axis O5 and the sixth pivot axis O6 is referred to as an axis coordinate P5 (predetermined portion). The hand 150 is attached to a distal surface of the sixth arm 16, and the center axis of the hand 150 coincides with the sixth pivot axis O6 of the sixth arm 16.

Although not illustrated in FIG. 28, the joints 171 to 176 respectively have a plurality of drive unit 130 and a plurality of position sensors 131 (refer to FIG. 2). The robot LA has drive units 130 and position sensors 131 whose number (six in the embodiment) is the same as those of the six joints 171 to 176 (or six arms 11 to 16).

As illustrated in FIG. 29, similarly to the robot 1 in the above-described first embodiment, in the robot 1A having this configuration, the base coordinate system (xr-axis, yr-axis, and zr-axis) is set based on the base 110 of the robot LA. In the base coordinate system, a center point of the upper end surface of the base 110 is set as an original point. Similarly, in the robot 1A, the distal coordinate system (xa-axis, ya-axis, and za-axis) is set based on the fifth arm 15 of the robot 1A. In the embodiment, in the distal coordinate system, the axis coordinate P5 of the fifth arm 15 is set as the original point. The calibration is previously completed between the base coordinate system and the distal coordinate system, and the robot 1A is in a state where the coordinates of the distal coordinate system can be calculated, based on the base coordinate system.

### Mobile Camera

As illustrated in FIG. 28, the mobile camera 3 is disposed in the fifth arm 15 of the robot 1A. In the embodiment, the mobile camera 3 is attached to the fifth arm 15 so that the optical axis A3 of the mobile camera 3 is substantially parallel to the sixth pivot axis O6 of the fifth arm 15 in design. Here, the robot 1A has the first arm 11, the fourth arm 14, and the sixth arm 16 which serve as three members capable of pivoting around the yaw axis with respect to the base 110. Therefore, in the embodiment, the mobile camera 3 is disposed in the fifth arm 15 (arm) positioned on the base 110 side from the sixth arm 16. Since the mobile camera 3 is disposed in the fifth arm 15, the position of the mobile camera 3 can be changed in response to the driving (pivoting) of the fifth arm 15.

The robot arm 10A serving as the “movable unit” belonging to the robot 1 having this configuration is configured to include the sixth arm 16 serving as the “distal arm” disposed closer on the distal side of the robot arm 10A serving as the “movable unit” than the fifth arm 15 as the “arm”. That is, in the robot 1A, the mobile camera 3 is disposed in the fifth arm 15. Similarly to the first embodiment, the robot 1A having this configuration can also perform the calibration (various settings and performances for the calibration) under the control of the control device 5. In this manner, the fifth arm 15 other than the sixth arm 16 serving as the “distal arm” positioned on the most distal side of the robot arm 10A can be used as the “arm” having the mobile camera 3 set therein. Therefore, for example, it is possible to minimize a possibility that the wire (not illustrated) of the mobile camera 3 pulled from the proximal side of the robot 1A may be degraded after being frequently bent due to the rotation of the sixth arm 16.

As illustrated in FIG. 30, the calibration in the embodiment is substantially the same as the calibration in the first implementation except that the mobile camera 3 is disposed in the fifth arm 15 and Steps S17 to S24 are omitted. Thus, detailed description thereof will be omitted. In the calibration according to the embodiment, the axis coordinate P5 may be used instead of the axis coordinate P2 in the calibration according to the first embodiment, and the fifth pivot axis O5 may be used instead of the second axis J2. Performing the calibration (S25) in the embodiment is substantially the same as performing the calibration (Step S24) in the first embodiment.

Without being limited to the mobile camera 3 disposed in the fifth arm 15, the control device 5 in the embodiment may be capable of performing the mapping between the image coordinate system of the mobile camera 3 disposed in the arms 11 to 15 other than the sixth arm 16 positioned in the most distal end of the robot arm 10 and the distal coordinate system of the robot 1. That is, the control device 5 can perform the mapping relating to the image coordinate system of the mobile camera 3 disposed in any one of the first arm 11, the second arm 12, the third arm 13, the fourth arm 14, and the fifth arm 15.

In the robot system 100A according to the embodiment, as described above, the mobile camera 3 is disposed in the fifth arm 15 (one preceding arm) positioned closer on the base 110 side than the sixth arm 16 pivoting around the sixth pivot axis O6 serving as the yaw axis positioned third from the base 110 in the first pivot axis O1, the fourth pivot axis O4, and the sixth pivot axis O6 whose pivoting axes (yaw in the embodiment)) are the same as that of the optical axis A3. The control device 5 included in the robot system 100A according to the embodiment can particularly more accurately perform the mapping on the mobile camera 3 disposed in this location.

In the embodiment, the work surface (upper surface) of the work table 91 on which the robot 1A carries out the work is parallel to the horizontal plane. However, the work surface may not be parallel to the horizontal plane, and may be inclined with respect to the horizontal plane. In this case, it is preferable to set in advance a virtual reference plane parallel to the work surface and defined based on the base coordinate system.

### Third Embodiment

Next, a third embodiment will be described.

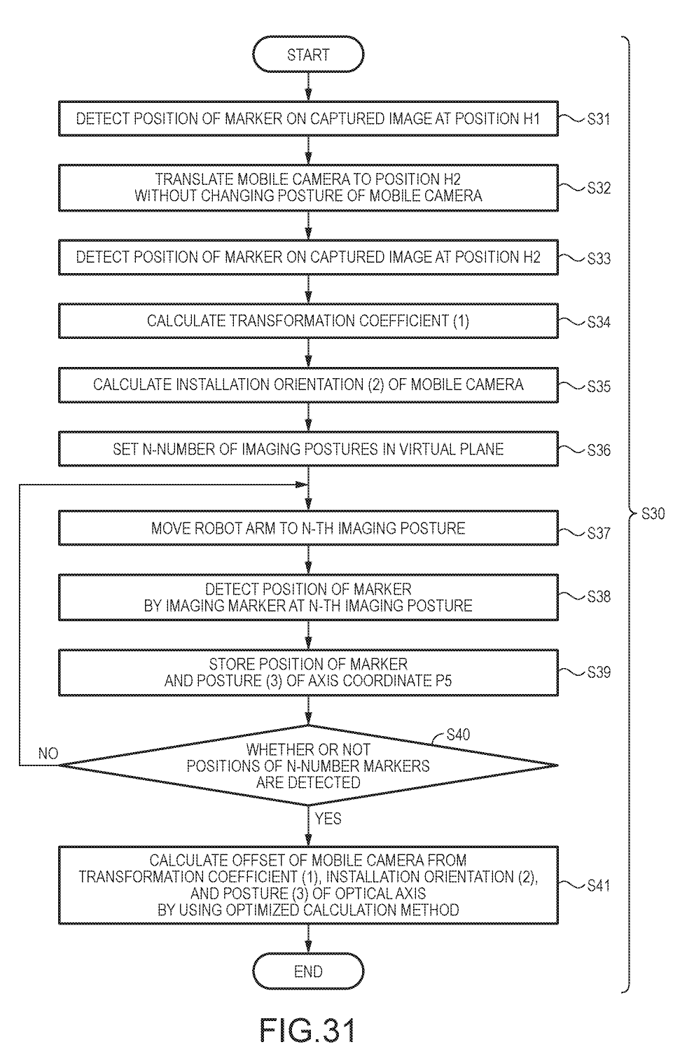

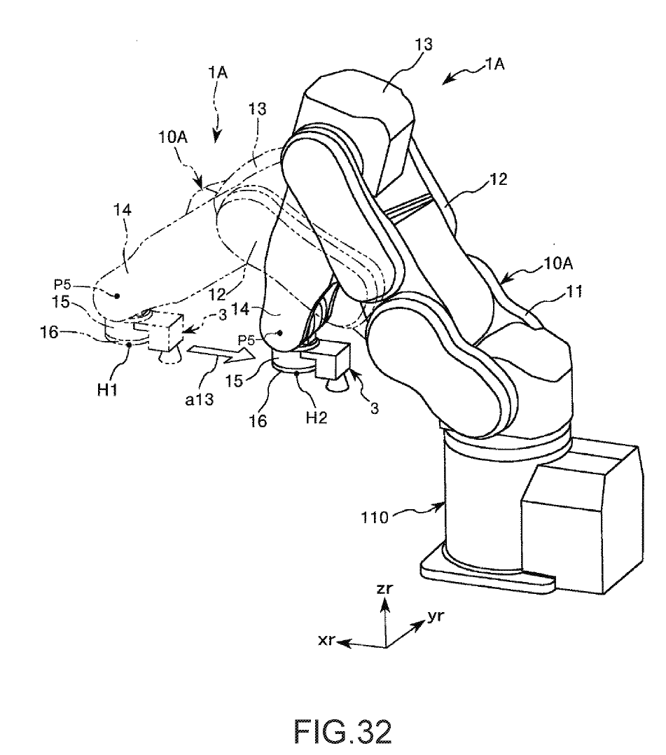

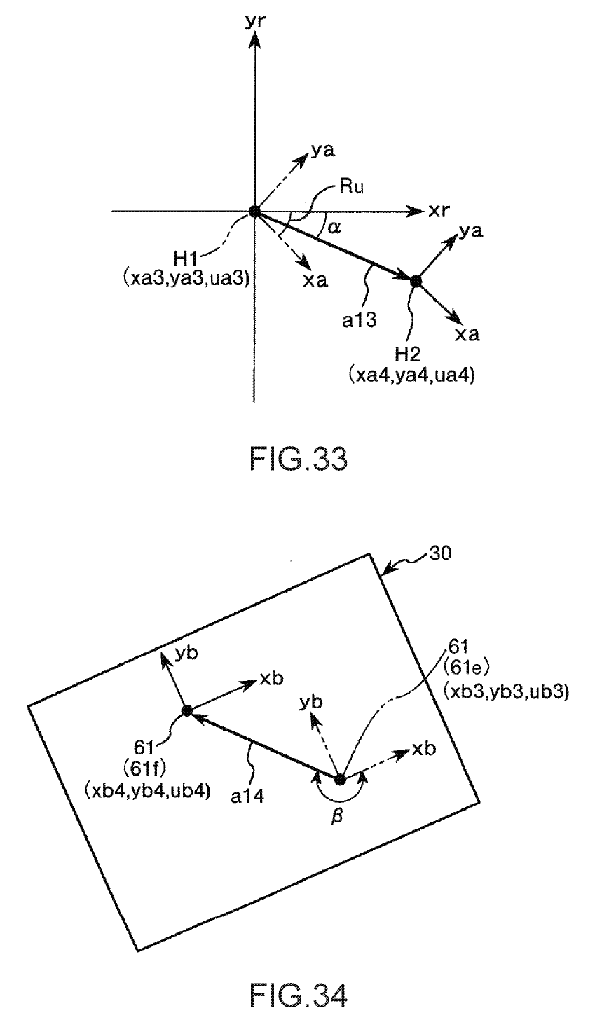

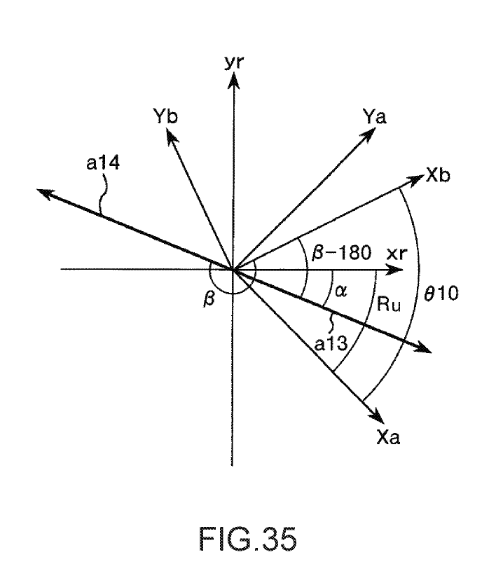

FIG. 31 is a view illustrating a flow of offset calculation performed by the robot system according to a third embodiment. FIG. 32 is a perspective view of a robot for describing Steps S31 and S32 illustrated in FIG. 31. FIGS. 33 and 34 are views for respectively describing Step S34 illustrated in FIG. 31. FIG. 35 is a view for describing Step S35 illustrated in FIG. 31. In FIG. 32, the hand 150 is omitted in the illustration.

The robot system according to the embodiment is mainly the same as that according to the above-described second embodiment except for the different offset calculation of the mobile camera. In the following description, with regard to the third embodiment, points different from those in the above-described embodiments will be mainly explained to the center, and the same elements will be omitted in description.

### Calibration

In the embodiment, the offset of the mobile camera 3 is obtained with respect to the fifth arm 15 in the robot 2A in the second embodiment. For example, in the calibration according to the second embodiment, after the plurality of reference points are completely reset (FIG. 30: Step S16), and before the calibration starts (FIG. 30: Step S25), the offset of mobile camera 3 can be calculated (Step S30) (refer to FIG. 31). Specifically, in the embodiment, the misalignment (components xa, ya, and ua) of the position and the posture of the mobile camera 3 with respect to the fifth arm 15 is obtained.

Hereinafter, description will be continued with reference to a flowchart illustrated in FIG. 31.

First, the control unit 53 performs Steps S31 to S34, drives the robot arm 10A so as to change the position (components xb and yb) of the mobile camera 3 without changing the posture (components ub, vb, and wb) and the position (component zb) of the mobile camera 3, and obtains the transformation coefficient (mm/pixel: resolution), based on the image coordinates and the robot coordinates before and after the position is changed.

In advance, the control unit 53 drives the robot arm 10A so that the axis coordinate P5 is positioned at an optional position H1. That is, for example, the robot 1A is brought into a state indicated by the two-dot chain line in FIG. 32.

Detecting of a Position 61e of the Marker 61 on the Captured Image 30 at the Position H1 (FIG. 31: Step S31).

First, the control unit 53 acquires image data by the mobile camera 3, and detects the position 61e (marker position) of the marker 61 on the captured image 30 at the position H1 (refer to FIGS. 32 to 34). The storage unit 55 stores the robot coordinates (xa3, ya3, and ua3) at the position H1 and the image coordinates (xb3, yb3, and ub3) at the position 61e (refer to FIGS. 33 and 34).

Translating the Mobile Camera 3 to a Position H2 without Changing the Posture of the Mobile Camera 3 (FIG. 31: Step S32).

Next, the control unit 53 drives the robot arm 10A so as to translate the axis coordinate P5 without changing the posture (components ub, vb, and wb) and the position (component zb) of the mobile camera 3. That is, for example, a state of the robot 1A illustrated by the two-dot chain line in FIG. 32 is changed to a state of the robot 1A illustrated by the solid line in FIG. 32. For example, without pivoting the first pivot axis O1, the fourth pivot axis O4, and the sixth pivot axis O6, this change can be realized by pivoting the second pivot axis O2, the third pivot axis O3 and the fifth pivot axis O5 (refer to FIGS. 29 and 32). In this manner, the axis coordinate P5 is positioned at the position H2 moved from the position H1 in a direction of an arrow a13 (refer to FIGS. 32 and 33). At this time, the marker 61 appearing in the captured image 30 is positioned at a position 61f (marker position) moved from the position 61e in a direction of an arrow a14 (refer to FIG. 34).

Detecting the Position 61f of the Marker 61 on the Captured Image 30 at the Position H2 (FIG. 31: Step S33).

Next, the control unit 53 acquires the image data from the mobile camera 3, and detects the position 61f (marker position) of the marker 61 on the captured image 30 at the position H2 (refer to FIG. 34). The storage unit 55 stores the robot coordinates (xa4, ya4, and ua4) at the position H2 and the image coordinates (xb4, yb4, and ub4) at the position 61f (refer to FIGS. 33 and 34).

### Calculating the Transformation Coefficient (1) (FIG. 31: Step S34)

Next, the control unit 53 obtains the transformation coefficient (mm/pixel: resolution) of the image coordinates and the robot coordinates from the distance (mm) between position H1 and position H2, and from the distance (pixel) between the position of the marker 61 at the position 61e on the captured image 30, and the position of the marker 61 at position 61f. In other words, the control unit 53 obtains the transformation coefficient from the movement distance (mm) of the axis coordinate P5 (mobile camera 3) before and after the above-described mobile camera 3 is moved to two locations and the movement distance (pixel) of the marker 61 appearing on the captured image 30.

### Calculating an Installation Orientation (2) of the Mobile Camera 3 (FIG. 31: Step S35)

Next, based on the information in Steps S31 to S34, the installation orientation (specifically, the component ua) of the mobile camera 3 is calculated.

Specifically, as illustrated in FIG. 35, the orientation (angle Ru) of the distal coordinate system at the positions H1 and H2 in the base coordinate system, the movement direction (angle α) of the axis coordinate P5 from the position H1 to the position H2 in the base coordinate system, and the movement direction (angle β) from the position 61e to 61f of the marker 61 in the image coordinate system are used. From Equation (4) below, a frame direction of the captured image (angle θ10) in the coordinate system is obtained.

θ10=Ru−α+β−180 (4)

### Set the N-Number of Imaging Postures in the Virtual Plane (FIG. 30: Step S36)

Next, the control unit 53 sets the posture (specifically, the component ua of the optical axis A3 (installation axis of the mobile camera 3)) of the mobile camera 3 at the N-number of optional positions in the virtual plane. For example, the virtual plane is orthogonal to the optical axis A3, and the coordinate system (local coordinate system) defined based on the base coordinate system is set. The original point on the virtual plane is set to the axis coordinate P5 in the embodiment.

Moving the Robot Arm 10A to the n-Th Imaging Posture (FIG. 31: Step S37)

Next, the control unit 53 drives the robot arm 10A, and moves the robot arm 10A to the first imaging posture (the n-th imaging posture) in the N-number of imaging postures. A numerical value of N may be 3 or more. The number is optionally set. However, as the number increases, the accuracy of the offset calculation is further improved. In the embodiment, for example, N is set to 10.

Imaging the Marker 61 at the n-Th Imaging Posture, and Detecting the Position of the Marker 61 (FIG. 31: Step S38)

Next, based on the first image (n-th image) serving as the captured image 30 captured at the first imaging posture (n-th imaging posture), the control unit 53 detects the position (position n) of the marker 61 at the first imaging posture.

### Storing the Position of the Marker 61 and a Posture (3) of the Axis Coordinate P5 (FIG. 31: Step S39)

Next, the storage unit 55 stores the image coordinates (xb, yb, and ub) at the position of the marker 61 on the first image (n-th image) and the robot coordinates (xa, ya, and ua) at the first imaging posture (n-th imaging posture).

### Determination Whether or not a Position n of the N-Number of Markers 61 is Detected (FIG. 31: Step S40)

Next, the control unit 53 detects the position (position n) of the N-number of markers 61, and determines whether or not the position is stored. In the embodiment, since N is set to 10, n is set to 10. In a case where the position n is not detected, that is, if the N-number of markers 61 is not detected, the process returns to Step S37. In a case where the position n is detected, that is, in a case where the N-number of markers 61 is detected, the process proceeds to Step S41. In the embodiment, Steps S37 to S40 are repeated until n reaches 10. Therefore, next, the position of the marker 61 at the second imaging posture is detected, based on the second image serving as the captured image 30 captured at the second imaging posture. If n reaches 10, that is, if the first to the n-th images are acquired, the process proceeds to Step S41.

Calculating the Offset of the Mobile Camera 3 from the Transformation Coefficient (1), the Installation Orientation (2), and the Posture (3) of the Optical Axis A3 of the Mobile Camera 3 by Using an Optimized Calculation Method (FIG. 31: Step S41)

Hereinafter, a method for obtaining the offset (position relationship between the axis coordinate P5 and the marker 61 appearing in the mobile camera 3) of the mobile camera 3 by using the optimized calculation method will be described. In the embodiment, although the solution is calculated using the optimized calculation method, the solution may be analytically obtained.

In the optimized calculation method described below, in a case of using the optimized calculation method by positioning the light receiving surface 311 of the mobile camera 3 so as to be parallel to the work surface (for example, an upper surface of the work table 91) on which the robot 1A carries out the work (refer to FIG. 29), the position relationship between the axis coordinate P5 and the marker 61 appearing in the mobile camera 3 is considered in an environment confined to a two-dimensional coordinate system.

First, if the position of the marker 61 in the distal coordinate system and the axis coordinate P5 of the robot 1A having the mobile camera 3 installed therein are defined as follows, the offset of the mobile camera 3 in the distal coordinate system can be calculated as follows.

$$R\_J5 \_CAM = ( \begin{matrix}cos ( Tu ) & sin ( Tu ) & - Tx \cdot cos ( Tu ) - Ty \cdot sin ( Tu ) \\ - sin ( Tu ) & cos ( Tu ) & Tx \cdot sin ( Tu ) + Ty \cdot cos ( Tu ) \\ 0 & 0 & 1\end{matrix} )$$

$$R\_CAM \_J5 = ( \begin{matrix}cos ( Tu ) & - sin ( Tu ) & Tx \\ sin ( Tu ) & cos ( Tu ) & Ty \\ 0 & 0 & 1\end{matrix} )$$

$$ToolOffsetXYU ( TLx , TLy , TLz ) = ( - Tx \cdot cos ( Tu ) - Ty \cdot sin ( Tu ) , Tx \cdot sin ( Tu ) + Ty \cdot cos ( Tu ) , - Tu )$$

J5 represents the axis coordinate P5. CAM represents the optical axis A3 (position of the marker 61 when the marker 61 is positioned at the center O30 of the captured image 30) of the mobile camera 3. Tx, Ty, and Tu are unknown variables.

Similarly, if the position and the posture of the axis coordinate P5 in the base coordinate system are defined as follows, the coordinates of the fifth pivoting axis O5 can be calculated as follows.

$$BASE\_R \_J5 = ( \begin{matrix}cos ( Ru ) & sin ( Ru ) & - Rx \cdot cos ( Ru ) - Ry \cdot sin ( Ru ) \\ - sin ( Ru ) & cos ( Ru ) & Rx \cdot sin ( Ru ) + Ry \cdot cos ( Ru ) \\ 0 & 0 & 1\end{matrix} )$$

$$R\_J5 \_BASE = ( \begin{matrix}cos ( Ru ) & - sin ( Ru ) & Rx \\ sin ( Ru ) & cos ( Ru ) & Ry \\ 0 & 0 & 1\end{matrix} )$$

$$J 5 XYU ( J 5 X , J 5 Y , J 5 U ) = ( - Rx \cdot cos ( Ru ) - Ry \cdot sin ( Ru ) , Rx \cdot sin ( Ru ) + Ry \cdot cos ( Ru ) , - Ru )$$

BASE represents the center point (original point) of the upper end surface of the base 110. Rx, Ry, and Ru are unknown variables.

A position (Mx and My) of the marker 61 in the base coordinate system is defined as follows.

$$R\_BASE \_MARKER = ( \begin{matrix}M x \\ My \\ 1\end{matrix} )$$

In addition to the above-described definition, if the transformation coefficient (resolution) is set as Fx and Fy (pixel/mm) and the center O30 of the captured image 30 of the mobile camera 3 is set as Cx and Cy (pixel), the relationship between an image coordinate P′ (ub and vb) of the marker 61 and the position (Mx and My) of the marker 61 can be expressed using the following relational expression.

$${P}^{′} = ( \begin{matrix}ub \\ vb \\ 1\end{matrix} ) = ( \begin{matrix}Fx & 0 & Cx \\ 0 & Fy & Cy \\ 0 & 0 & 1\end{matrix} ) ( \begin{matrix}cos ( Tu ) & - sin ( Tu ) & Tx \\ sin ( Tu ) & cos ( Tu ) & Ty \\ 0 & 0 & 1\end{matrix} ) ( \begin{matrix}cos ( Ru ) & - sin ( Ru ) & Rx \\ sin ( Ru ) & cos ( Ru ) & Ry \\ 0 & 0 & 1\end{matrix} ) ( \begin{matrix}M x \\ My \\ 1\end{matrix} )$$

In the above equation, after the transformation coefficient Fx and Fy is measured in advance, Tx, Ty, Tu, Mx, and My are set as the unknown variables, and the optimized calculation method is used. The unknown variables Tx, Ty, Tu, Mx, and My are calculated by setting the position of the marker 61 imaged at the N-number of postures Rₙ of the robot 1A as Pₙ and by minimizing an error evaluating function E below.

$$Rn ( {R}_{x}^{n} , {R}_{y}^{n} , {R}_{u}^{n} )$$

$${P}_{n} ( {P}_{x}^{n} , {P}_{y}^{n} )$$

$$E = {\sum }_{n = 0}^{m - 1} {( {P}_{n} - {P}_{n}^{′} )}^{T} \cdot ( {P}_{n} - {P}_{n}^{′} )$$

Minimizing the error evaluating function E is performed using the multivariate Newton method according to Procedures 1 to 5 below.

### Procedure 1

An initial value X⁰ is determined as follows.

X⁰=(Tₓ⁰,T_{y}⁰,Tᵤ⁰,Mₓ⁰,M_{y}⁰)^{T}

For example, the initial value is set using the following values.

Tx=0, Ty=0,

As Tu, the installation orientation of the mobile camera 3 obtained in Step S35 is used. As Fx and Fy, the transformation coefficient obtained in Step S34 is used.

Mx=0, My=0

### Procedure 2

A gradient ∇E and a Hessian matrix H in a current value X are calculated.

$$∇ E ( X ) = {( \frac{\partial E}{\partial Tx} … \frac{\partial E}{\partial My} )}^{T}$$

$$H ( X ) = ( \begin{matrix}\frac{{\partial }^{2} E}{\partial {T}_{x}^{2}} & … & \frac{{\partial }^{2} E}{\partial {T}_{x} \partial {M}_{y}} \\ ⋮ & ⋱ & ⋮ \\ \frac{{\partial }^{2} E}{\partial {M}_{y} \partial {T}_{x}} & … & \frac{{\partial }^{2} E}{\partial {M}_{y}^{2}}\end{matrix} )$$

### Procedure 3

A solution ΔXn of the simultaneous equations is calculated.

H(Xₙ)ΔXₙ−∇E(Xₙ)

### Procedure 4

A value Xn is updated.

Xₙ₊₁=Xₙ+ΔXₙ

### Procedure 5

If ΔXₙ<δ is satisfied, Xn is returned. In other cases, Procedure 2 to Procedure 5 are repeated.

Through the above-described procedures, the unknown variables Tx, Ty, Tu, Mx, and My are obtained, and the offset of the mobile camera 3 can be obtained. Calculating the offset of the mobile camera 3 using this optimized calculation method can be used instead of Step S17 (specifically, Step S172 to Step S174) in the first embodiment. In this case, the axis coordinate P5 may be replaced with the axis coordinate P2.

In the above-described optimized calculation method, in a case where a value of the angle θ10 described above is used as the unknown variable Tu, only the four variables Tx, Ty, Mx, and My are calculated. Therefore, in this case, a numerical value of N in Step S37 may be 2 or more.

As described above, the control device 5 controls the robot 1A having the robot arm 10A serving as the “movable unit” including the fifth arm 15 serving as the “arm” provided with the mobile camera 3 serving as the “imaging unit”. The control device 5 includes the control unit 53 that obtains the posture (component ua) of the mobile camera 3 serving as the “imaging unit” by translating the fifth arm 15 serving as the “arm” (Steps S31 to S35). According to the control device 5, the fifth arm 15 is translated. In this manner, it is possible to obtain the posture (component ua) of the mobile camera 3 with respect to the fifth arm 15. Therefore, the fifth arm 15 other than the sixth arm 16 serving as the “distal arm” located on the most distal side of the robot arm 10A can be used as the “arm” having the mobile camera 3 set therein. As a result, for example, it is possible to minimize a possibility that the wire (not illustrated) of the mobile camera 3 pulled from the base 110 due to the excessive pivoting of the sixth arm 16 may be degraded after being frequently bent due to the rotation of the sixth arm 16. Here, the term of translation means linearly moving within a plane (excluding rotation and arc-shaped movement).

For example, in applications of a relatively small pivoting amount of the sixth arm 16, the “arm” provided with the mobile camera 3 serving as the “imaging unit” may be the sixth arm 16. Even in this case, the sixth arm 16 is translated. In this manner, it is possible to minimize a possibility that the wire may be degraded after being frequently bent due to the rotation of the sixth arm 16.

As described above, the control unit 53 obtains the posture (component ua) of the mobile camera 3 serving as the “imaging unit”, based on the translation direction (in the embodiment, the translation direction of the axis coordinate P 5), the direction of translating the fifth arm 15 serving as the “arm” (in the embodiment, the direction of translating the axis coordinate P5), and the movement direction in the coordinate system (image coordinate system) of the mobile camera 3 serving as the “imaging unit” in response to the translation of the fifth arm 15 as the “arm”. Specifically, as described above, the posture of the mobile camera 3 is obtained in Step S35. In this manner, the posture of the mobile camera 3 can be obtained with respect to the fifth arm 15 without excessively pivoting the robot arm 10.

In particular, as described above, the control unit 53 obtains the offset of the mobile camera 3 with respect to the fifth arm 15 serving as the “arm”, based on the marker 61 (marker recognition position) imaged by the mobile camera 3 serving as the “imaging unit”. In this manner, for example, it is unnecessary to measure the offset by using a measure (measuring instrument). Therefore, it is possible to minimize the artificial variations in the touch-up work by measuring the offset by using the measure (measuring instrument), for example. The offset can be calculated in a non-contact manner. Accordingly, it is possible to more accurately calculate the offset regardless of the material of the object 60, for example.

Specifically, as described above, the control unit 53 obtains the offset, based on the first image (captured image 30) in which the marker 61 is imaged by positioning the mobile camera 3 serving as the “imaging unit” at the first imaging posture and the second image (captured image 30) in which the marker 61 is imaged by positioning the mobile camera 3 at the second imaging posture. In the embodiment, as described above, the offset is obtained, based on the first to tenth images. In this manner, the offset can be calculated in a non-contact manner, and the offset can be more accurately calculated using a relatively simple method.

As described above, the robot 1A is controlled by the control device 5, and has the robot arm 10A serving as the “the movable unit” including the fifth arm 15 serving as the “arm” provided with the mobile camera 3 serving as the “imaging unit”. According to this robot 1A, as described above, it is possible to accurately perform the operation relating to the calculation of the offset.

The robot system 100A in the embodiment as described above includes the robot 1A having the control device 5, the mobile camera 3 serving as the “imaging unit”, and the robot arm 10A controlled by the control device 5 and serving as the “movable unit” including the fifth arm 15 serving as the “arm” provided with the mobile camera 3 serving as the “imaging unit”. According to this robot system 100A, under the control of the control device 5, the robot 1A can accurately perform the operation relating to the calculation of the offset. For example, it is possible to minimize a possibility that the wire (not illustrated) of the mobile camera 3 pulled from the base 110 of the robot 1A may be degraded after being frequently bent due to the rotation of the sixth arm 16.

In a case where the sixth arm 16 is not excessively rotated, the installation location of the mobile camera 3 may be the distal arm (sixth arm 16). The same is applied to the robot 1 in the first embodiment. The “arm” is not limited to the fifth arm 15, and may be the arm provided with the “imaging unit”.

### Fourth Embodiment

Next, a fourth embodiment will be described.

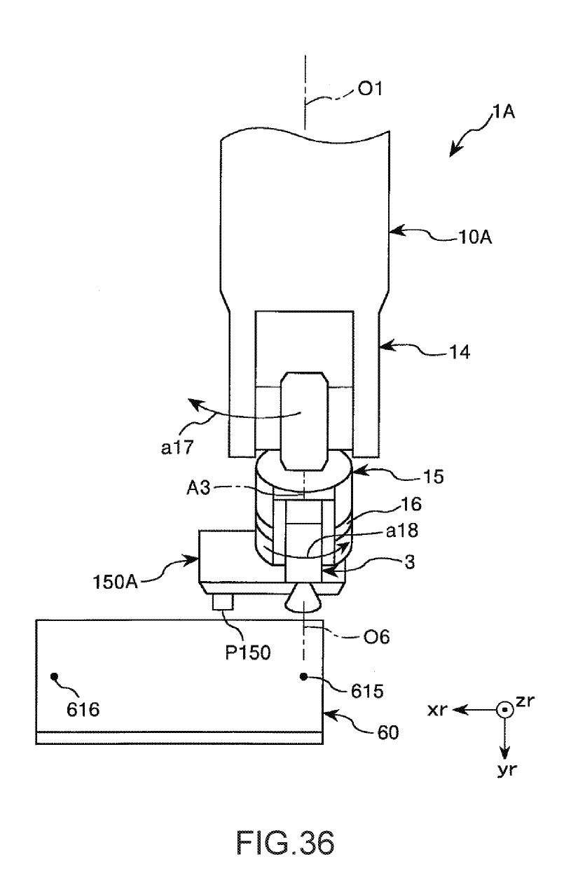

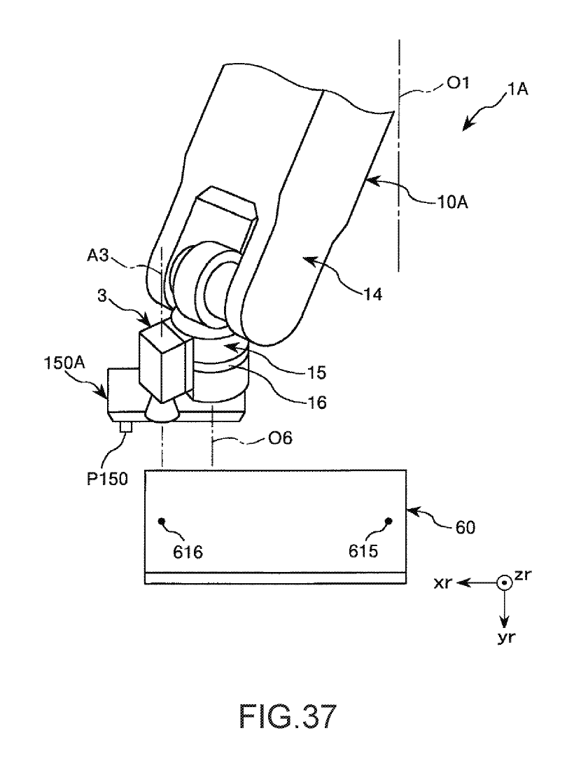

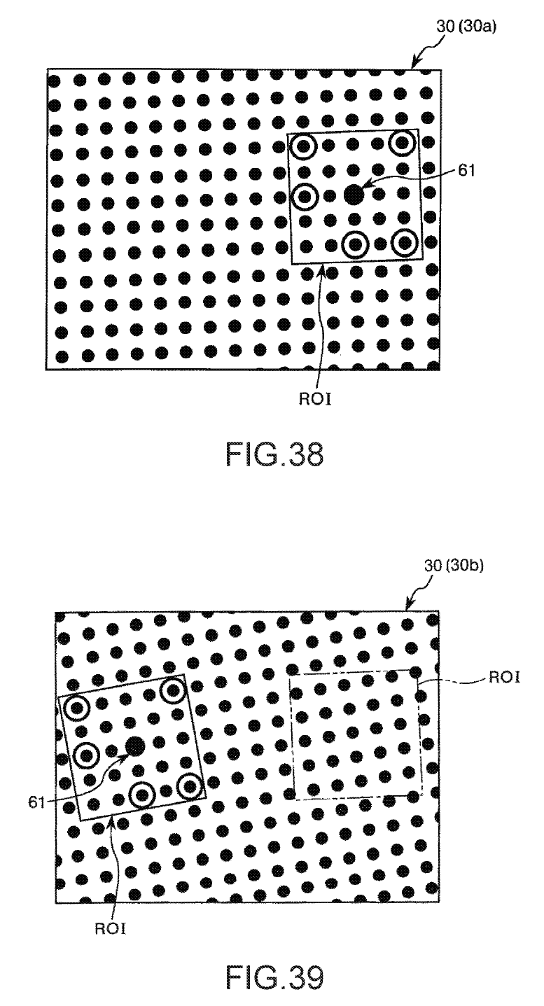

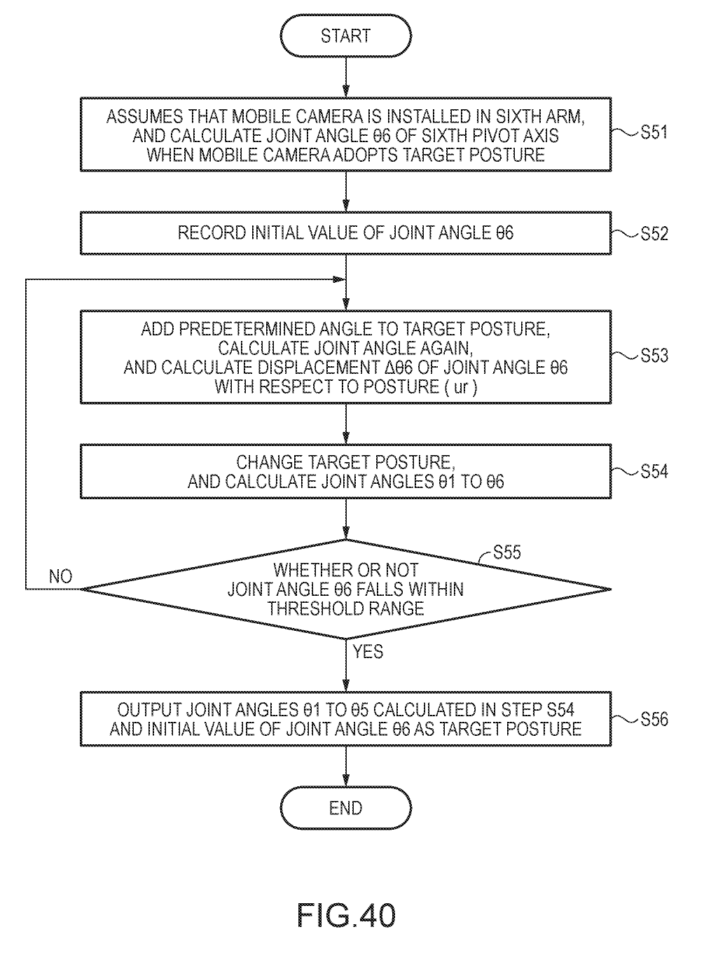

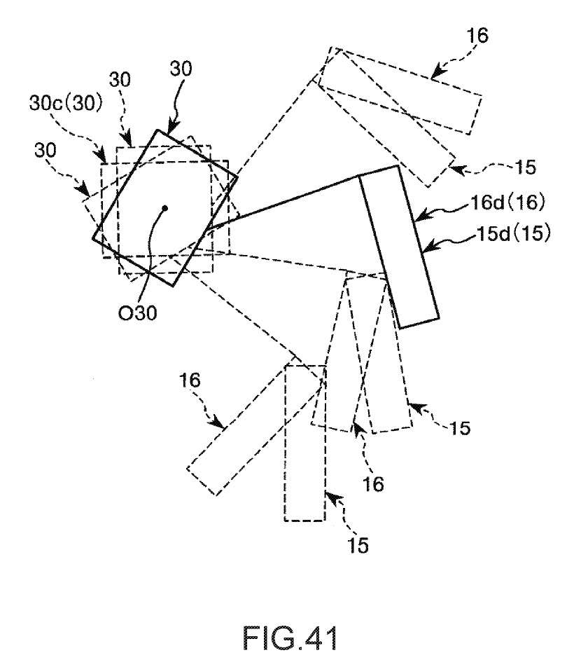

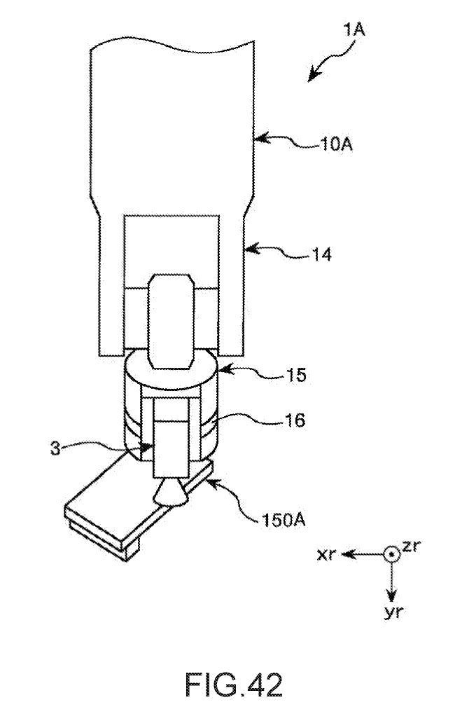

FIG. 36 is a view illustrating a distal portion of a robot belonging to a robot system according to a fourth embodiment. FIG. 37 is a view illustrating a state of translating a hand belonging to the robot illustrated in FIG. 36. FIG. 38 is a view illustrating a captured image in a state of the robot illustrated in FIG. 36. FIG. 39 is a view illustrating the captured image in the state of the robot illustrated in FIG. 37. FIG. 40 is a flowchart illustrating a process for positioning a mobile camera installed in a robot arm illustrated in FIG. 36 at a target location. FIG. 41 is a view for describing Step S55 illustrated in FIG. 40. FIG. 42 is a view illustrating a state where the hand is positioned within the field of view of the mobile camera in the robot illustrated in FIG. 36.

The robot system according to the embodiment is mainly the same as that according to the above-described third embodiment except for the different configuration of the hand and additional processing performed by the control unit. In the following description, with regard to the fourth embodiment, points different from those in the above-described embodiments will be mainly described, and the same elements will be omitted in description.

A hand 150A belonging to the robot 1A illustrated in FIG. 36 protrudes outward from the sixth arm 16 when viewed from the sixth pivot axis O6. In the robot 1A having such a hand 150A, for example, if a distal end P150 of the hand 150A is translated in the +yr direction by performing so-called jog feeding in order to move the mobile camera 3 from a position on a spot 615 of the object 60 to a position on a spot 616 positioned in the +xr direction, the sixth arm 16 pivots around the sixth pivot axis O6 (in a direction of an arrow a18) (refer to FIGS. 36 and 37). At this time, the fifth arm 15 pivots around an axis parallel to the first pivot axis O1 (in a direction of an arrow a17). In response to the pivoting of the fifth arm 15, the mobile camera 3 also pivots around the first pivot axis (in a direction of the arrow a17). Due to the pivoting of the mobile camera 3, the frame of the captured image 30 similarly pivots (refer to FIGS. 38 and 39).

In this way, for example, when the hand 150A is translated, the rotation component of the fifth arm 15 is applied to the movement of the mobile camera 3. Therefore, for example, if the mobile camera 3 is attempted to move to the target location by performing so-called jog feeding with reference to the distal end P150 of the hand 150A illustrated in FIG. 36, the center O30 of the captured image 30 is less likely to be properly positioned at the target location.

Therefore, in the embodiment, the control unit 53 controls the robot arm 10A so that the mobile camera 3 can be properly moved to the target location (for example, the spot 616), that is, so that the target location appears at the center O30 of the captured image 30. Hereinafter, description will be continued with reference to a flowchart illustrated in FIG. 40. In the following description, a process for properly positioning the mobile camera 3 at the target location is performed in a state where the offset in the above-described third embodiment is completely calculated.

First, the control unit 53 assumes that the mobile camera 3 is installed in the sixth arm 16, and calculates a joint angle θ6 of the sixth pivot axis O6 when the mobile camera 3 adopts a target posture (xr, yr, zr, ur, vr, and wr) (Step S51). Here, in the embodiment, for example, the target posture is a position/posture of the mobile camera 3 taking a position/posture of a captured image 30c (captured image 30) in FIG. 41. For example, the joint angle θ6 is an angle of a distal center (axis coordinate of the sixth pivot axis O6) of the sixth arm 16 in the axis coordinate P5.

Next, the storage unit 55 records the joint angle θ6 obtained in Step S51 as an initial value (Step S52).

Next, the control unit 53 calculates again the joint angle θ6 by adding a predetermined angle (for example, 1°) to the target posture (ur), and calculates a displacement Δθ6 of the joint angle θ6 with respect to the posture (ur) (Step S53).

Next, the control unit 53 changes the target posture (ur) so that the joint angle θ6 is 0 (zero), and calculates joint angles θ1 to θ6 (Step S54). Specifically, the target posture (ur) in Step S51 is set as “ura”, the joint angle θ6 obtained in Step S51 is set as “θ6A”, and the target posture (ur) to be newly obtained in Step S54 is set as “urb”. The target posture (urb) is obtained using ura, θ6A, Δθ6 obtained in Step S53, and Equation (5) below. The control unit 53 calculates the joint angle θ1 to θ6 of the first pivot axis O1 to the sixth pivot axis O6 in the new target posture (urb).

$$urb = ura - ( \frac{θ 6 A}{Δ θ 6} ) \qquad ( 5 )$$

Next, the control unit 53 determines whether or not the joint angle θ6 obtained in Step S54 falls within a predetermined threshold range (Step S55). In a case where the joint angle θ6 does not fall within the predetermined threshold range, the process returns to Step S53. On the other hand, in a case where the joint angle θ6 falls within the predetermined threshold range, the process proceeds to Step S56. Here, the predetermined threshold range is a preset value. For example, the joint angle θ6 is preferably 0°. Accordingly, as a value within the threshold range, it is preferable that the value falls within ±10°, and more preferable ±0.1°. For example, in a case where the joint angle θ6 is 0°, the arms are in a state of the fifth arm 15d (fifth arm 15) and the sixth arm 16d (sixth arm 16) illustrated in FIG. 41. That is, the arms are in a state where the center axis of the fifth arm 15 (axis orthogonal to the fifth pivot axis O5) and the sixth pivot axis O6 coincide with each other. Therefore, for example, Steps S53 to S55 are repeatedly performed until a state of the fifth arm 15 and the sixth arm 16 illustrated by the dashed line in FIG. 41 is changed to a state of the fifth arm 15d and the sixth arm 16d illustrated by the solid line.

In a case where convergence cannot be obtained in Step S55 even if Steps S53 to S55 are repeatedly performed multiple times, Steps S53 to S55 may be repeatedly performed by changing the initial value at each optional angle (for example, 30°) until the convergence is obtained.

Next, if it is determined that the joint angle θ6 falls within the predetermined threshold range, the control unit 53 sets the joint angles θ1 to θ5 calculated in Step S54 and the initial value of the joint angle θ6 stored in Step S52 as the target posture, and outputs the target posture to the robot 1A (Step S56).

According to the above-described configuration, the process for positioning the mobile camera 3 at the target location is completed. Here, as described above, the robot LA has the base 110 which supports the robot arm 10A serving as the “movable unit”. The fifth arm 15 serving as the “arm” is capable of pivoting with respect to the base 110, and the sixth arm 16 serving as the “distal arm” is capable of pivoting with respect to the fifth arm 15. As described above, in view of the pivoting of the mobile camera 3 serving as the “imaging unit” pivoting in response to the pivoting of the fifth arm 15, the control unit 53 performs the process for moving the mobile camera 3 (in the embodiment, the center O30 of the captured image 30 of the mobile camera 3) to a designated position (refer to FIG. 40). In this manner, the mobile camera 3 can be properly positioned at the designated position. Since the process for properly positioning the mobile camera 3 at the target location is used, various tools (not illustrated) disposed in the fifth arm 15 other than the mobile camera 3 can be properly positioned at the target location.

As illustrated in FIG. 42, in the robot 1A having the hand 150A having the above-described configuration, if the sixth arm 16 pivots, the hand 150A pivots in response to the pivoting. In some cases, the hand 150A may be positioned below the mobile camera 3 (in the region directly below). Therefore, in some cases, the hand 150A may be positioned within the field of view of the mobile camera 3, and the mobile camera 3 may not view the object 60. For example, when the mobile camera 3 is positioned at the target location in the processing for positioning the mobile camera 3 at the target location, the mobile camera 3 may not view the object 60 in some cases.

Therefore, the control unit 53 sets a distal axis angle (joint angle of the hand 150A) of the hand 150A so that the hand 150A is not positioned within the field of view of the mobile camera 3.

Specifically, for example, the storage unit 55 stores information relating to the distal axis angle of the hand 150A in a state where the hand 150A is not positioned within the field of view of the mobile camera 3, and the control unit 53 controls the movement of the mobile camera 3 (fifth arm 15), based on this information.

For example, in a case where the hand 150A is not positioned in the field of view of the mobile camera 3 before and after the mobile camera 3 is moved, the control unit 53 causes the storage unit 55 to store the distal axis angle of the hand 150A at that position. Even after the mobile camera 3 is moved, the control unit 53 maintains the distal axis angle of the hand 150A before the mobile camera 3 is moved.

For example, the control unit 53 sets in advance the range of the distal axis angle of the hand 150A in a state where the hand 150A is not positioned within the field of view of the mobile camera 3. Based on the range of the distal axis angle of the hand 150A and the target posture of the mobile camera 3, the control unit 53 sets the distal axis angle (component ur of the distal axis posture) nearest to the target distal axis angle within a range where both of these do not overlap each other.

In this way, the control unit 53 controls the robot arm 10A so that the robot arm 10A serving as the “movable unit” does not appear in the captured image 30 captured by the mobile camera 3 serving as the “imaging unit”. Even if the marker 61 is imaged by the mobile camera 3 installed in the fifth arm 15, it is possible to avoid the robot arm 10A from appearing in the captured image 30.

In particular, as described above, the mobile camera 3 serving as the “imaging unit” can image the distal side of the robot arm 10A serving as the “movable unit”. The control unit 53 controls the robot 10A so that the distal portion (for example, the hand 150A) of the robot arm 10A does not appear in the captured image 30. Even if the marker 61 is imaged by the mobile camera 3 installed in the fifth arm 15, it is possible to avoid the hand 150A from appearing in the captured image 30. Therefore, the offset can be more accurately calculated and calibrated using the captured image 30.

In the robot 1 according to the first embodiment, the control unit 53 also controls the robot arm 10 so that the robot arm 10 does not appear in the captured image 30.

In the embodiment, as illustrated in FIG. 38, a region ROI (region of interest) is set as an imaging target region for detecting an imaging target in the captured image 30. In this manner, the imaging target can be quickly detected. Here, if the captured image 30 pivots so that a state illustrated in FIG. 38 is changed to a state illustrated in FIG. 39, the position of the marker 61 serving as the imaging target is deviated from the region ROI illustrated by the two-dot chain line in FIG. 38. Therefore, in the embodiment, as illustrated by the solid line in FIG. 39, the region ROI is caused to pivot in response to the pivoting of the captured image 30. For example, in a case where the mobile camera 3 is rotated +10° around the ua-axis of the axis coordinate P5, the region ROI is caused to pivot around the ub-axis so as to be rotated −10° around the ua-axis. Even if the mobile camera 3 (captured image 30) pivots in response to the pivoting of the fifth arm 15, the imaging target can be properly detected within the captured image 30.

Hitherto, the control device, the robot, and the robot system according to the invention have been described with reference to the illustrated embodiments. However, the invention is not limited thereto. The configuration of each unit can be replaced with any optional configuration having the same function. Any other configuration may be added to the invention. The respective embodiments may be appropriately combined with each other.

The number of robot arms is not particularly limited, and may be two or more. The number of pivot axes of the robot arm is not particularly limited, and may be optionally determined.

The entire disclosure of Japanese Patent Application No. 2016-239872, filed Dec. 9, 2016 is expressly incorporated by reference herein.

What is claimed is:

1. A control device which controls a robot having a movable unit including an arm provided with an imaging unit, the control device comprising:
at least one processor,
wherein the processor obtains a posture of the imaging unit by translating the arm.

2. The control device according to claim 1,
wherein the processor obtains the posture of the imaging unit, based on a direction of translating the arm and a movement direction in a coordinate system of the imaging unit in response to the translation of the arm.

3. The control device according to claim 1,
wherein the processor obtains an offset of the imaging unit with respect to the arm, based on a marker imaged by the imaging unit.

4. The control device according to claim 3,
wherein the processor obtains the offset, based on a first image in which the marker is imaged by positioning the imaging unit at a first imaging posture and a second image in which the marker is imaged by positioning the imaging unit at a second imaging posture.

5. The control device according to claim 1,
wherein the movable unit includes a distal arm disposed on a distal side of the movable unit from the arm.

6. The control device according to claim 5,
wherein the robot has a base which supports the movable unit,
wherein the arm is capable of pivoting with respect to the base,
wherein the distal arm is capable of pivoting with respect to the arm, and
wherein the processor moves the imaging unit to a designated position and posture, based on the pivoting of the imaging unit pivoting in response to the pivoting of the arm.

7. The control device according to claim 1,
wherein the processor controls the movable unit so that the movable unit does not appear in a captured image captured by the imaging unit.

8. The control device according to claim 7,
wherein the imaging unit is capable of imaging a distal side of the movable unit, and
wherein the processor controls the movable unit so that a distal portion of the movable unit does not appear in the captured image.

9. A robot controlled by the control device according to claim 1 and having a movable unit including an arm provided with an imaging unit.

10. A robot controlled by the control device according to claim 2 and having a movable unit including an arm provided with an imaging unit.

11. A robot controlled by the control device according to claim 3 and having a movable unit including an arm provided with an imaging unit.

12. A robot controlled by the control device according to claim 4 and having a movable unit including an arm provided with an imaging unit.

13. A robot controlled by the control device according to claim 5 and having a movable unit including an arm provided with an imaging unit.

14. A robot controlled by the control device according to claim 6 and having a movable unit including an arm provided with an imaging unit.

15. A robot controlled by the control device according to claim 7 and having a movable unit including an arm provided with an imaging unit.

16. A robot controlled by the control device according to claim 8 and having a movable unit including an arm provided with an imaging unit.

17. A robot system comprising:
the control device according to claim 1;
an imaging unit; and
a robot controlled by the control device and having a movable unit including an arm provided with the imaging unit.
